(19) United States
(12) Patent Application Publication
(10) Pub. No.: US 2006/0209132 A1
(43) Pub. Date: Sep. 21, 2006

(54) Inkjet printhead having isolated nozzles

(75) Inventors: Kia Silverbrook, Balmain (AU); Gregory John McAvoy, Dublin (IE)

Correspondence Address: SILVERBROOK RESEARCH PTY LTD, 393 DARLING STREET, BALMAIN, NSW 2041, AU

(73) Assignee: Kia Silverbrook and Gregory John McAvoy

(21) Appl. No.: 11/084,237

(22) Filed: Mar. 21, 2005

(51) Int. Cl. B41J 2/05

(52) U.S. Cl. 347/61

(57) ABSTRACT

A printhead suitable for minimizing cross-contamination between nozzles is provided. The printhead comprises a substrate, which includes a plurality of nozzles for ejecting ink droplets onto a print medium. Each nozzle has a nozzle aperture, which is defined in an ink ejection surface of the substrate. The printhead also comprises a plurality of formations on the ink ejection surface. The surface formations are configured to isolate each nozzle from at least one adjacent nozzle, and typically take the form of enclosures surrounding each nozzle.

### CO-PENDING APPLICATIONS

The following applications have been filed by the Applicant simultaneously with the present application:

| | |
|---|---|
| FIN002US | FIN003US |

The disclosures of these co-pending applications are incorporated herein by reference. The above applications have been identified by their filing docket number, which will be substituted with the corresponding application number, once assigned.

### CROSS REFERENCES TO RELATED APPLICATIONS

The following patents or patent applications filed by the applicant or assignee of the present invention are hereby incorporated by cross-reference.

| | | | | | | |
|---|---|---|---|---|---|---|
| 6795215 | 10/884881 | PEC01NP | 09/575109 | 10/296535 | 09/575110 | 6805419 |
| 09/607985 | 6398332 | 6394573 | 6622923 | 6747760 | 10/189459 | 10/943941 |
| 10/949294 | 10/727181 | 10/727162 | 10/727163 | 10/727245 | 10/727204 | 10/727233 |
| 10/727280 | 10/727157 | 10/727178 | 10/727210 | 10/727257 | 10/727238 | 10/727251 |
| 10/727159 | 10/727180 | 10/727179 | 10/727192 | 10/727274 | 10/727164 | 10/727161 |
| 10/727198 | 10/727158 | 10/754536 | 10/754938 | 10/727227 | 10/727160 | 10/934720 |
| 10/854521 | 10/854522 | 10/854488 | 10/854487 | 10/854503 | 10/854504 | 10/854509 |
| 10/854510 | 10/854496 | 10/854497 | 10/854495 | 10/854498 | 10/854511 | 10/854512 |
| 10/854525 | 10/854526 | 10/854516 | 10/854508 | 10/854507 | 10/854515 | 10/854506 |
| 10/854505 | 10/854493 | 10/854494 | 10/85489 | 10/854490 | 10/854492 | 10/854491 |
| 10/854528 | 10/854523 | 10/854527 | 10/854524 | 10/854520 | 10/854514 | 10/854519 |
| PLT036US | 10/854499 | 10/854501 | 10/854500 | 10/854502 | 10/854518 | 10/854517 |
| PLT043US | 10/728804 | 10/728952 | 10/728806 | 10/728834 | 10/729790 | 10/728884 |
| 10/728970 | 10/728784 | 10/728783 | 10/728925 | 10/728842 | 10/728803 | 10/728780 |
| 10/728779 | 10/773189 | 10/773204 | 10/773198 | 10/773199 | 10/773190 | 10/773201 |
| 10/773191 | 10/773183 | 10/773195 | 10/773196 | 10/773186 | 10/773200 | 10/773185 |
| 10/773192 | 10/773197 | 10/773203 | 10/773187 | 10/773202 | 10/773188 | 10/773194 |
| 10/773193 | 10/773184 | 10/760272 | 10/760273 | 10/760187 | 10/760182 | 10/760188 |
| 10/760218 | 10/760217 | 10/760216 | 10/760233 | 10/760246 | 10/760212 | 10/760243 |
| 10/760201 | 10/760185 | 10/760253 | 10/760255 | 10/760209 | 10/760208 | 10/760194 |
| 10/760238 | 10/760234 | 10/760235 | 10/760183 | 10/760189 | 10/760262 | 10/760232 |
| 10/760231 | 10/760200 | 10/760190 | 10/760191 | 10/760227 | 10/760207 | 10/760181 |
| 6746105 | 6623101 | 6406129 | 6505916 | 6457809 | 6550895 | 6457812 |
| 6428133 | IJ52NP | 10/407212 | 10/407207 | 10/683064 | 10/683041 | 10/882774 |
| 10/884889 | 10/922890 | JUM008US | 10/922885 | 10/922889 | 10/922884 | 10/922879 |
| 10/922887 | 10/922888 | 10/922874 | 10/922873 | 10/922871 | 10/922880 | 10/922881 |
| 10/922882 | 10/922883 | 10/922878 | JUM023US | 10/922876 | 10/922886 | 10/922877 |
| 10/815625 | 10/815624 | 10/815628 | 10/913375 | 10/913373 | 10/913374 | 10/913372 |
| 10/913377 | 10/913378 | 10/913380 | 10/913379 | 10/913376 | 10/913381 | 10/986402 |
| 09/575187 | 6727996 | 6591884 | 6439706 | 6760119 | 09/575198 | 09/722148 |
| 09/722146 | 09/721861 | 6290349 | 6428155 | 6785016 | 09/608920 | 09/721892 |
| 09/722171 | 09/721858 | 09/722142 | 10/171987 | 10/202021 | 10/291724 | 10/291512 |
| 10/291554 | 10/659027 | 10/659026 | 10/831242 | 10/884885 | 10/884883 | 10/901154 |
| 10/932044 | 10/962412 | 10/962510 | 10/962552 | 10/965733 | 10/965933 | 10/974742 |
| 10/986375 | 10/659027 | 09/693301 | 09/575197 | 09/575195 | 09/575159 | 09/575132 |
| 09/575123 | 09/575148 | 09/575130 | 09/575165 | 6813039 | 09/575118 | 09/575131 |
| 09/575116 | 6816274 | 09/575139 | 09/575186 | 6681045 | 6728000 | 09/575145 |
| 09/575192 | 09/575181 | 09/575193 | 09/575183 | 6789194 | 09/575150 | 6789191 |
| 6549935 | 09/575174 | 09/575163 | 6737591 | 09/575154 | 09/575129 | 09/575124 |
| 09/575188 | 09/575189 | 09/575170 | 09/575171 | 09/575161 | 6644642 | 6502614 |
| 6622999 | 6669385 | 11/003786 | 11/003354 | CAA003US | 11/003418 | 11/003334 |
| CAA006US | 11/003404 | 11/003419 | 11/003700 | CAA010US | CAA011US | CAA012US |
| 11/003337 | CAA014US | 11/003420 | CAA016US | CAA017US | 11/003463 | CAC001US |
| 11/003683 | CAE001US | 11/003702 | 11/003684 | CAF003US | CAF004US | 10/760254 |
| 10/760210 | 10/760202 | 10/760197 | 10/760198 | 10/760249 | 10/760263 | 10/760196 |
| 10/760247 | 10/760223 | 10/760264 | 10/760244 | 10/760245 | 10/760222 | 10/760248 |
| 10/760236 | 10/760192 | 10/760203 | 10/760204 | 10/760205 | 10/760206 | 10/760267 |
| 10/760270 | 10/760259 | 10/760271 | 10/760275 | 10/760274 | 10/760268 | 10/760184 |
| 10/760195 | 10/760186 | 10/760261 | 10/760258 | RRB001US | RRB002US | RRB003US |
| RRB004US | RRB005US | RRB006US | RRB007US | RRB008US | RRB009US | RRB010US |
| RRB011US | RRB012US | RRB013US | RRB014US | RRB015US | RRB016US | RRB017US |
| RRB018US | RRB019US | RRB020US | RRB021US | RRB022US | RRB023US | RRB024US |
| RRB025US | RRB026US | RRB027US | RRB030US | RRB031US | RRB032US | RRB033US |
| RRC001US | RRC002US | RRC003US | RRC004US | RRC005US | RRC006US | RRC007US |
| RRC008US | RRC009US | RRC010US | RRC011US | RRC012US | RRC013US | RRC014US |
| RRC015US | RRC016US | RRC017US | RRC018US | RRC019US | RRC020US | RRC021US |
| 6750901 | 6476863 | 6788336 | 6322181 | | | |

Some applications have been listed by docket numbers. These will be replaced when application numbers are known.

### FIELD OF THE INVENTION

The present invention relates to the field of inkjet printers and, discloses an inkjet printing system using printheads manufactured with microelectro-mechanical systems (MEMS) techniques.

### BACKGROUND OF THE INVENTION

Many different types of printing have been invented, a large number of which are presently in use. The known forms of print have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years, the field of ink jet printing, wherein each individual pixel of ink is derived from one or more ink nozzles has become increasingly popular primarily due to its inexpensive and versatile nature.

Many different techniques on inkjet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different types. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous ink jet printing including the step wherein the ink jet stream is modulated by a high frequency electrostatic field so as to cause drop separation. This technique is still utilized by several manufacturers including Elmjet and Scitex (see also U.S. Pat. No. 3,373,437 by Sweet et al)

Piezoelectric ink jet printers are also one form of commonly utilized ink jet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode of operation of a piezoelectric crystal, Stemme in U.S. Pat. No. 3,747,120 (1972) discloses a bend mode of piezoelectric operation, Howkins in U.S. Pat. No. 4,459,601 discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclosed ink jet printing techniques that rely upon the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction operation, durability and consumables.

A problem with inkjet printheads, and especially inkjet printheads having a high nozzle density, is that ink can flood across the printhead surface contaminating adjacent nozzles. This is undesirable because it results in reduced print quality. Moreover, cross-contamination of ink across the printhead surface can potentially result in electrolysis and accelerated corrosion of nozzle actuators.

Previous attempts to minimize ink flooding across the printhead surface typically involve coating the printhead with a hydrophobic material. However, hydrophobic coatings have only had limited success in minimizing the extent of flooding.

A further problem with inkjet printheads, especially inkjet printheads having senstitive MEMS nozzles formed on an ink ejection surface of the printhead, is that the nozzle structures can become damaged by cleaning the printhead surface. Typically, printheads are wiped regularly to remove particles of paper dust or paper fibers, which build up on the ink ejection surface. When a wiping mechanism comes into contact with nozzle structures on the printhead surface, there is an obvious risk of damaging the nozzles.

It would be desirable to provide a printhead, which minimizes cross-contamination by ink flooding between adjacent nozzles. It would be further desirable to provide a printhead, which allows regular cleaning of the printhead surface by a wiping mechanism without risk of damaging nozzle structures on the printhead.

### SUMMARY OF THE INVENTION

In a first aspect, there is provided a printhead comprising:

a substrate including a plurality of nozzles for ejecting ink droplets onto a print medium, each nozzle having a nozzle aperture defined in an ink ejection surface of the substrate; and

a plurality of formations on the ink ejection surface, the surface formations being configured to isolate each nozzle from at least one adjacent nozzle.

In a second aspect, there is provided a method of operating a printhead, whilst minimizing cross-contamination of ink between adjacent nozzles, the method comprising the steps of:

(a) providing a printhead comprising:

a substrate including a plurality of nozzles for ejecting ink droplets onto a print medium, each nozzles having a nozzle aperture defined in an ink ejection surface of the substrate; and

a plurality of formations on the ink ejection surface, the surface formations being configured to isolate each nozzle from at least one adjacent nozzle; and

(b) printing onto a print medium using said printhead.

In a third aspect, there is provided a method of fabricating a printhead having isolated nozzles, the method comprising the steps of:

(a) providing a substrate, the substrate including a plurality of nozzles for ejecting ink droplets onto a print medium, each nozzle having a nozzle aperture defined in an ink ejection surface of the substrate;

(b) depositing a layer of photoresist over the ink ejection surface;

(c) defining recesses in the photoresist, each recess revealing a portion of the ink ejection surface surrounding a respective nozzle aperture;

(d) depositing a roof material over the photoresist and into the recesses;

(e) etching the roof material to define a nozzle enclosure around each nozzle aperture, each nozzle enclosure having an opening defined in a roof and sidewalls extending from the roof to the ink ejection surface; and

(f) removing the photoresist.

Optionally, the formations have a hydrophobic surface. Inkjet inks are typically aqueous-based inks and hydrophobic formations will repel any flooded ink. Hence, hydrophobic formations minimize as far as possible any cross-contamination of ink by acting as a physical barrier and by intermolecular repulsive forces. Moreover, hydrophobic formations promote ingestion of any flooded ink back into respective nozzle chambers and ink supply channels. Since nozzle chambers are typically hydrophilic, ink will tend to be drawn back into the nozzle and away from a surrounding hydrophobic formation.

Optionally, the formations are arranged in a plurality of nozzle enclosures, each nozzle enclosure comprising sidewalls surrounding a respective nozzle, the sidewalls forming a seal with the ink ejection surface. Hence, each nozzle is isolated from its adjacent nozzles by a nozzle enclosure.

Optionally, each nozzle enclosure further comprises a roof spaced apart from the respective nozzle, the roof having a roof opening aligned with a respective nozzle opening for allowing ejected ink droplets to pass therethrough onto the print medium. Hence, each nozzle enclosure may typically take the form of a cap, which covers or encapsulates an individual nozzle on the ink ejection surface. The roof not only provides additional containment of any flooded ink, it also provides further protection of each nozzle from, for example, the potentially damaging effects of paper dust, paper fibers or wiping.

Typically, the sidewalls extend from a perimeter region of each roof to the ink ejection surface. Sidewalls of adjacent nozzle enclosures are usually spaced apart across the ink ejection surface.

Optionally, the printhead is an inkjet printhead, such as a pagewidth inkjet printhead. Optionally, the printhead has a nozzle density, which is sufficient to print at up to 1600 dpi. The present invention is particularly beneficial for printheads having a high nozzle density, because high density printheads are especially prone to flooding between adjacent nozzles.

### BRIEF DESCRIPTION OF THE DRAWINGS

Notwithstanding any other forms that may fall within the scope of the present invention, preferred forms of the invention will now be described, by way of example only, with reference to the accompanying drawings in which:

FIG. 1 is a schematic cross-sectional view through an ink chamber of a unit cell of a printhead according to an embodiment using a bubble forming heater element;

FIG. 2 is a schematic cross-sectional view through the ink chamber FIG. 1, at another stage of operation;

FIG. 3 is a schematic cross-sectional view through the ink chamber FIG. 1, at yet another stage of operation;

FIG. 4 is a schematic cross-sectional view through the ink chamber FIG. 1, at yet a further stage of operation; and

FIG. 5 is a diagrammatic cross-sectional view through a unit cell of a printhead in accordance with an embodiment of the invention showing the collapse of a vapor bubble.

FIG. 6 is a schematic, partially cut away, perspective view of a further embodiment of a unit cell of a printhead.

FIGS. 7 to 20 are schematic perspective views of the unit cell shown in FIG. 6, at various successive stages in the fabrication process of the printhead.

### DESCRIPTION OF OPTIONAL EMBODIMENTS

Bubble Forming Heater Element Actuator

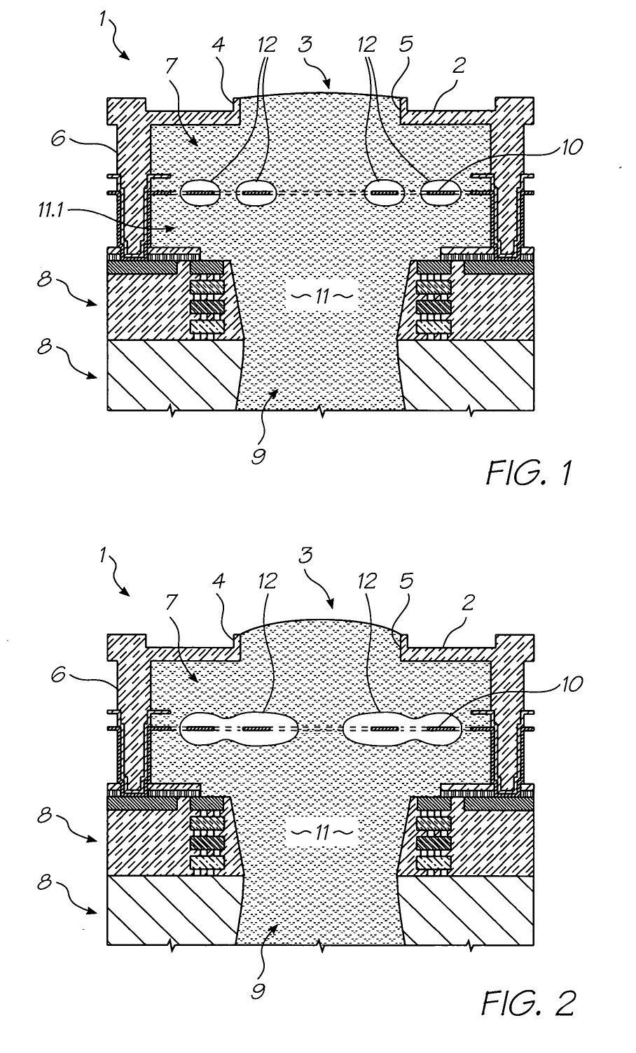

With reference to FIGS. 1 to 4, the unit cell 1 of one of the Applicant's printheads is shown. The unit cell 1 comprises a nozzle plate 2 with nozzles 3 therein, the nozzles having nozzle rims 4, and apertures 5 extending through the nozzle plate. The nozzle plate 2 is plasma etched from a silicon nitride structure which is deposited, by way of chemical vapor deposition (CVD), over a sacrificial material which is subsequently etched.

The printhead also includes, with respect to each nozzle 3, side walls 6 on which the nozzle plate is supported, a chamber 7 defined by the walls and the nozzle plate 2, a multi-layer substrate 8 and an inlet passage 9 extending through the multi-layer substrate to the far side (not shown) of the substrate. A looped, elongate heater element 10 is suspended within the chamber 7, so that the element is in the form of a suspended beam. The printhead as shown is a microelectromechanical system (MEMS) structure, which is formed by a lithographic process which is described in more detail below.

When the printhead is in use, ink 11 from a reservoir (not shown) enters the chamber 7 via the inlet passage 9, so that the chamber fills to the level as shown in FIG. 1. Thereafter, the heater element 10 is heated for somewhat less than 1 microsecond, so that the heating is in the form of a thermal pulse. It will be appreciated that the heater element 10 is in thermal contact with the ink 11 in the chamber 7 so that when the element is heated, this causes the generation of vapor bubbles 12 in the ink. Accordingly, the ink 11 constitutes a bubble forming liquid. FIG. 1 shows the formation of a bubble 12 approximately 1 microsecond after generation of the thermal pulse, that is, when the bubble has just nucleated on the heater elements 10. It will be appreciated that, as the heat is applied in the form of a pulse, all the energy necessary to generate the bubble 12 is to be supplied within that short time.

When the element 10 is heated as described above, the bubble 12 forms along the length of the element, this bubble appearing, in the cross-sectional view of FIG. 1, as four bubble portions, one for each of the element portions shown in cross section.

The bubble 12, once generated, causes an increase in pressure within the chamber 7, which in turn causes the ejection of a drop 16 of the ink 11 through the nozzle 3. The rim 4 assists in directing the drop 16 as it is ejected, so as to minimize the chance of drop misdirection.

The reason that there is only one nozzle 3 and chamber 7 per inlet passage 9 is so that the pressure wave generated within the chamber, on heating of the element 10 and forming of a bubble 12, does not affect adjacent chambers and their corresponding nozzles. The pressure wave generated within the chamber creates significant stresses in the chamber wall. Forming the chamber from an amorphous ceramic such as silicon nitride, silicon dioxide (glass) or silicon oxynitride, gives the chamber walls high strength while avoiding the use of material with a crystal structure. Crystalline defects can act as stress concentration points and therefore potential areas of weakness and ultimately failure.

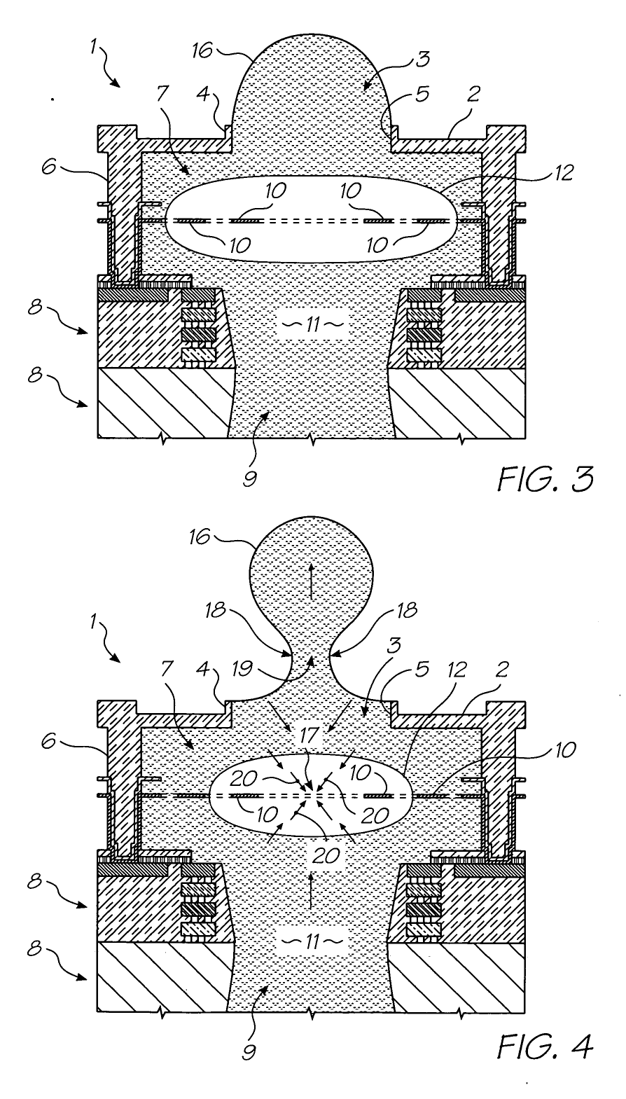

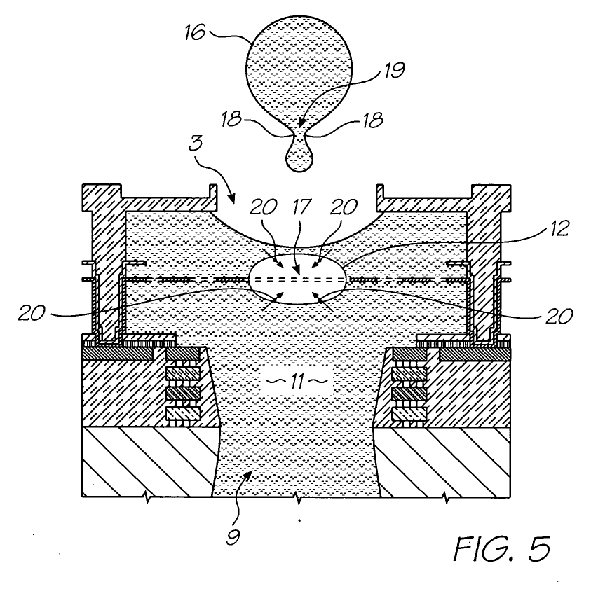

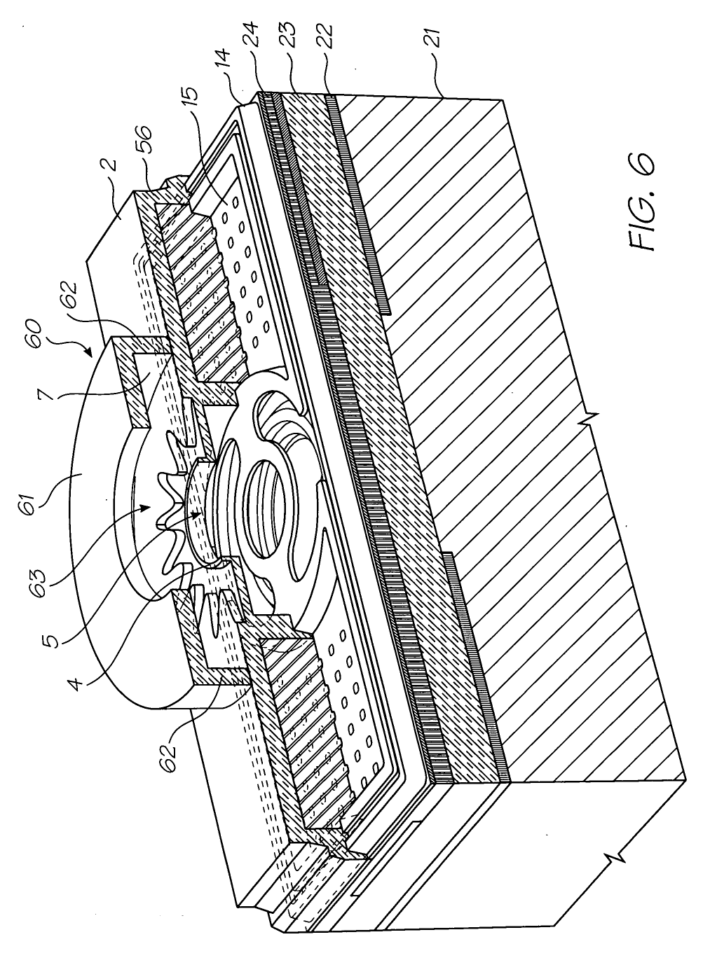

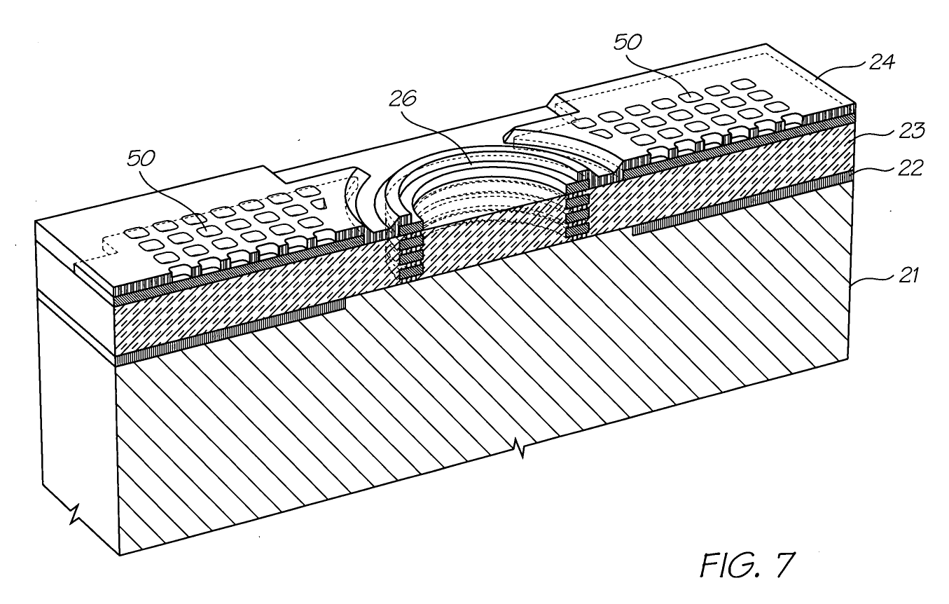

FIGS. 2 and 3 show the unit cell 1 at two successive later stages of operation of the printhead. It can be seen that the bubble 12 generates further, and hence grows, with the resultant advancement of ink 11 through the nozzle 3. The shape of the bubble 12 as it grows, as shown in FIG. 3, is determined by a combination of the inertial dynamics and the surface tension of the ink 11. The surface tension tends to minimize the surface area of the bubble 12 so that, by the time a certain amount of liquid has evaporated, the bubble is essentially disk-shaped.

The increase in pressure within the chamber 7 not only pushes ink 11 out through the nozzle 3, but also pushes some ink back through the inlet passage 9. However, the inlet passage 9 is approximately 200 to 300 microns in length, and is only approximately 16 microns in diameter. Hence there is a substantial viscous drag. As a result, the predominant effect of the pressure rise in the chamber 7 is to force ink out through the nozzle 3 as an ejected drop 16, rather than back through the inlet passage 9.

Turning now to FIG. 4, the printhead is shown at a still further successive stage of operation, in which the ink drop 16 that is being ejected is shown during its “necking phase” before the drop breaks off. At this stage, the bubble 12 has already reached its maximum size and has then begun to collapse towards the point of collapse 17, as reflected in more detail in FIG. 21.

The collapsing of the bubble 12 towards the point of collapse 17 causes some ink 11 to be drawn from within the nozzle 3 (from the sides 18 of the drop), and some to be drawn from the inlet passage 9, towards the point of collapse. Most of the ink 11 drawn in this manner is drawn from the nozzle 3, forming an annular neck 19 at the base of the drop 16 prior to its breaking off.

The drop 16 requires a certain amount of momentum to overcome surface tension forces, in order to break off. As ink 11 is drawn from the nozzle 3 by the collapse of the bubble 12, the diameter of the neck 19 reduces thereby reducing the amount of total surface tension holding the drop, so that the momentum of the drop as it is ejected out of the nozzle is sufficient to allow the drop to break off.

When the drop 16 breaks off, cavitation forces are caused as reflected by the arrows 20, as the bubble 12 collapses to the point of collapse 17. It will be noted that there are no solid surfaces in the vicinity of the point of collapse 17 on which the cavitation can have an effect.

Advantages of Nozzle Enclosures

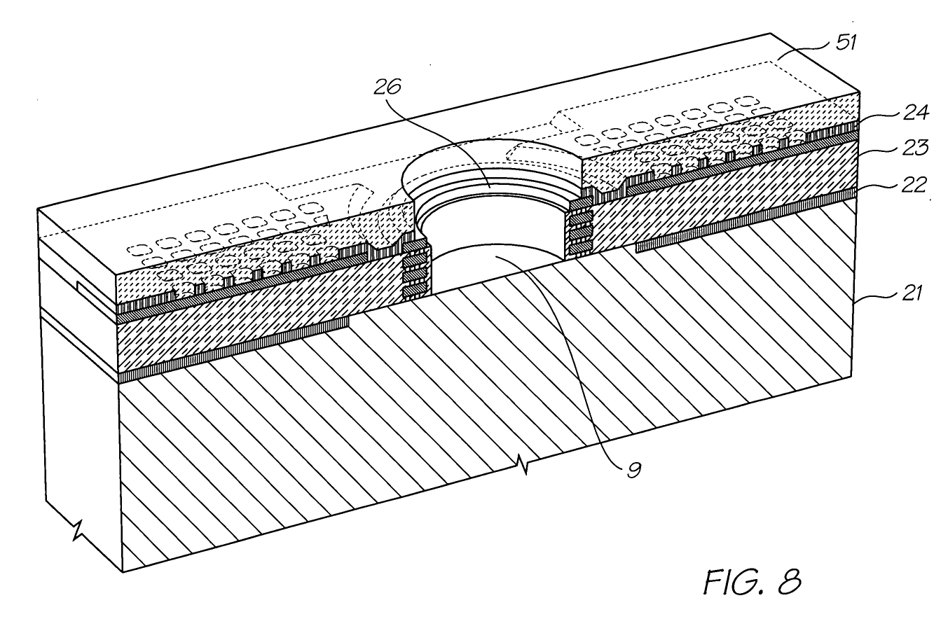

Referring to FIG. 6, an embodiment of the unit cell 1 according to the invention is shown. The aperture 5 is surrounded by a nozzle enclosure 60, which isolates adjacent apertures on the printhead. The nozzle enclosure 60 has a roof 61 and sidewalls 62, which extend from the roof to the nozzle plate 2 and form a seal therewith. An opening 63 is defined in the roof 61, which allows ink droplets (not shown) to pass through the nozzle enclosure and onto a print medium (not shown).

The nozzle enclosure 60 minimize cross-contamination between adjacent apertures 5 by containing any flooded ink in the immediate vicinity of each nozzle. Flooding of ink from each nozzle may be caused by a variety of reasons, such as nozzle misfires or pressure fluctuations in ink supply channels. The nozzle enclosure may be formed from or coated with a hydrophobic material during the fabrication process, which further minimizes the risk of cross-contamination.

A further advantage of the printhead according to the invention is that it allows the nozzle plate 2 of the printhead to be wiped without risk of damaging the sensitive nozzle structures. Typically, inkjet printheads are cleaned by a wiping mechanism as part of a warm-up cycle. The nozzle enclosures 60 provide a protective barrier between the nozzles and the wiping mechanism (not shown).

Fabrication Process

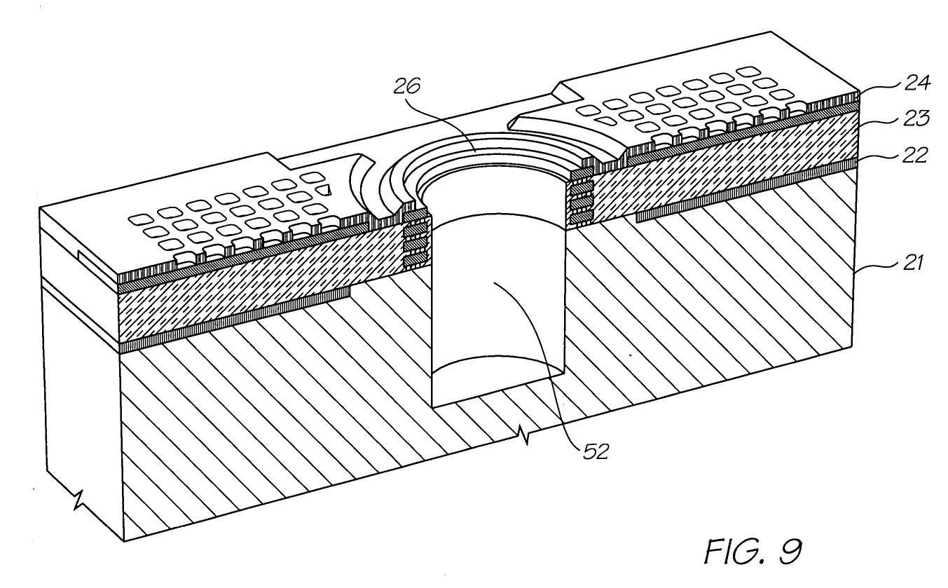

In the interests of brevity, the fabrication stages have been shown for the unit cell of FIG. 6 only (see FIGS. 7 to 20). It will be appreciated that the other unit cells will use the same fabrication stages with different masking.

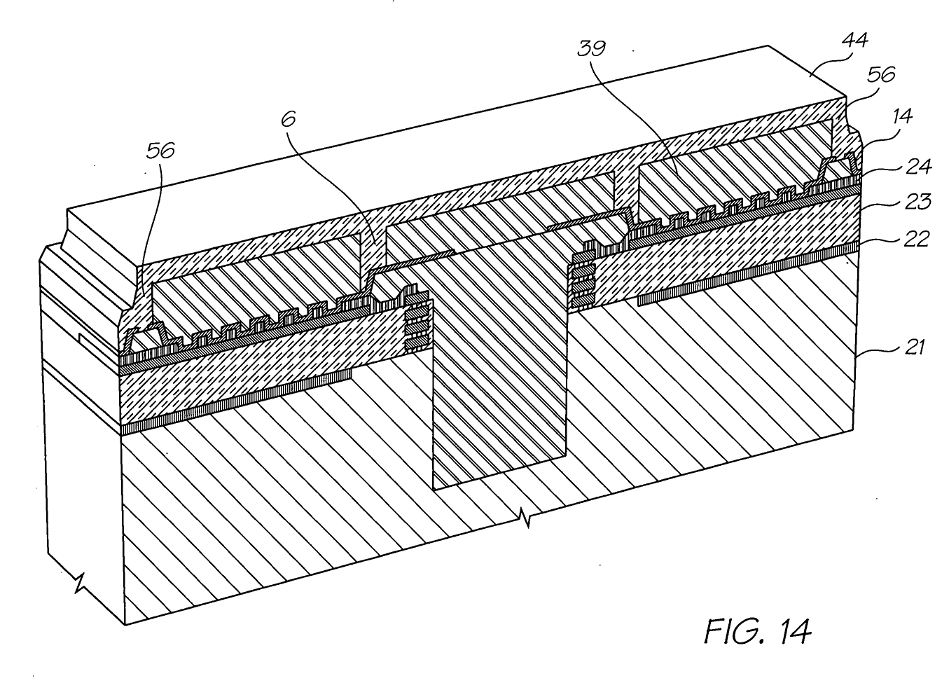

Referring to FIG. 7, there is shown the starting point for fabrication of the thermal inkjet nozzle shown in FIG. 13. CMOS processing of a silicon wafer provides a silicon substrate 21 having drive circuitry 22, and an interlayer dielectric (“interconnect”) 23. The interconnect 23 comprises four metal layers, which together form a seal ring for the inlet passage 9 to be etched through the interconnect. The top metal layer 26, which forms an upper portion of the seal ring, can be seen in FIG. 7. The metal seal ring prevents ink moisture from seeping into the interconnect 23 when the inlet passage 9 is filled with ink.

A passivation layer 24 is deposited onto the top metal layer 26 by plasma-enhanced chemical vapour deposition (PECVD). After deposition of the passivation layer 24, it is etched to define a circular recess, which forms parts of the inlet passage 9. At the same as etching the recess, a plurality of vias 50 are also etched, which allow electrical connection through the passivation layer 24 to the top metal layer 26. The etch pattern is defined by a layer of patterned photoresist (not shown), which is removed by O₂ ashing after the etch.

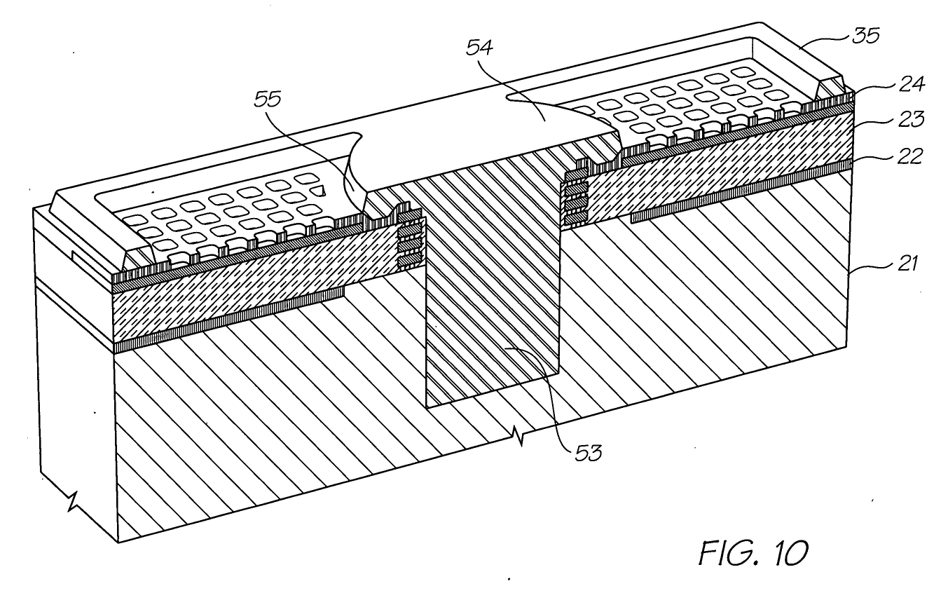

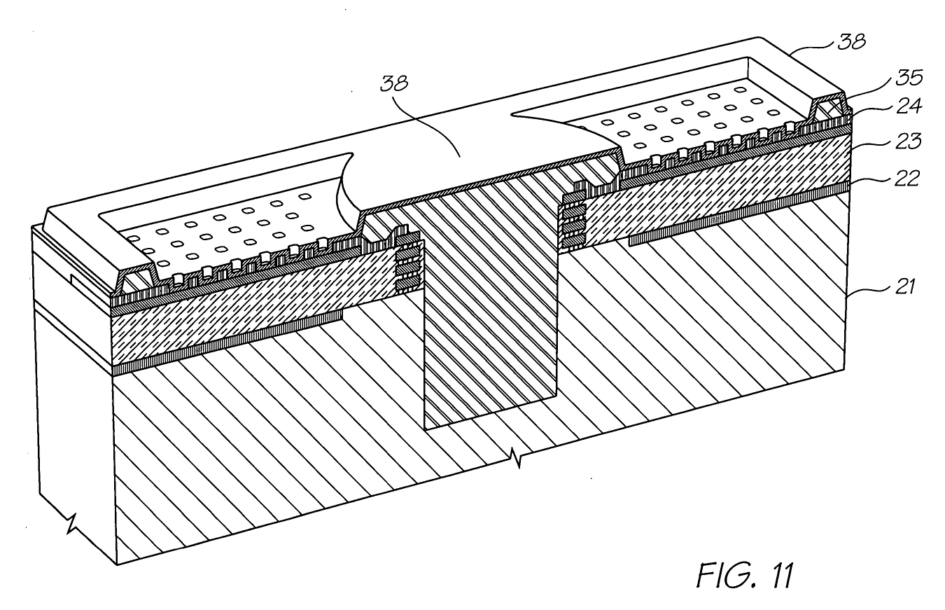

Referring to FIG. 8, in the next fabrication sequence, a layer of photoresist is spun onto the passivation later 24. The photoresist is exposed and developed to define a circular opening. With the patterned photoresist 51 in place, the dielectric interconnect 23 is etched as far as the silicon substrate 21 using a suitable oxide-etching gas chemistry (e.g. O₂/C₄F₈). Etching through the silicon substrate is continued down to about 20 microns to define a front ink hole 52, using a suitable silicon-etching gas chemistry (e.g. ‘Bosch etch’). The same photoresist mask 51 can be used for both etching steps. FIG. 9 shows the unit cell after etching the front ink hole 52 and removal of the photoresist 51.

Referring to FIG. 10, in the next stage of fabrication, the front ink hole 52 is plugged with photoresist to provide a front plug 53. At the same time, a layer of photoresist is deposited over the passivation layer 24. This layer of photoresist is exposed and developed to define a first sacrificial scaffold 54 over the front plug 53, and scaffolding tracks 35 around the perimeter of the unit cell. The first sacrificial scaffold 54 is used for subsequent deposition of heater material 38 thereon and is therefore formed with a planar upper surface to avoid any buckling in the heater element (see heater element 10 in FIG. 10). The first sacrificial scaffold 54 is UV cured and hardbaked to prevent reflow of the photoresist during subsequent high-temperature deposition onto its upper surface.

Importantly, the first sacrificial scaffold 54 has sloped or angled side faces 55. These angled side faces 55 are formed by adjusting the focusing in the exposure tool (e.g. stepper) when exposing the photoresist. The sloped side faces 55 advantageously allow heater material 38 to be deposited substantially evenly over the first sacrificial scaffold 54.

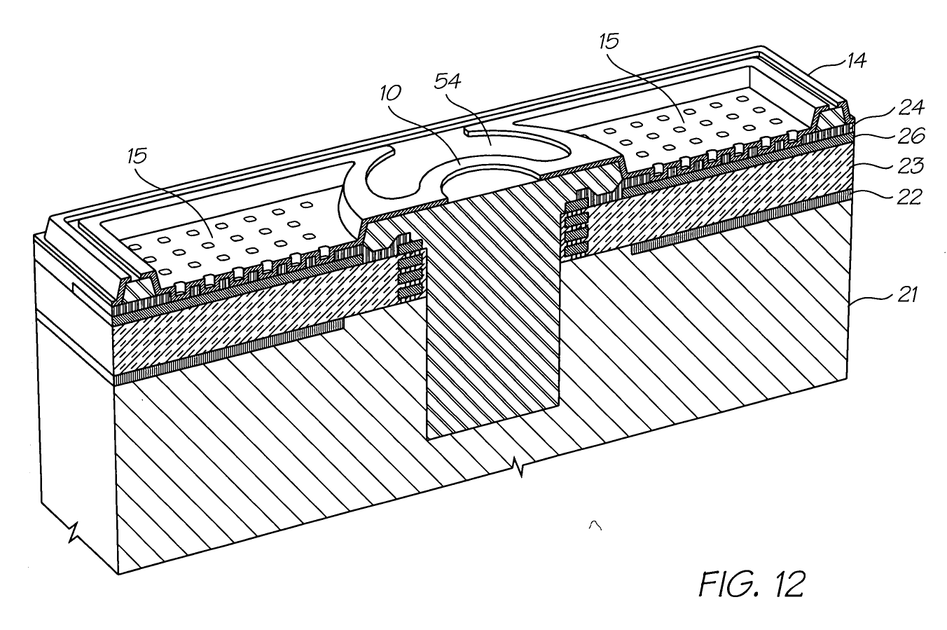

Referring to FIG. 11, the next stage of fabrication deposits the heater material 38 over the first sacrificial scaffold 54, the passivation layer 24 and the perimeter scaffolding tracks 35. The heater material 38 is typically a monolayer of TiAlN. However, the heater material 38 may alternatively comprise TiAlN sandwiched between upper and lower passivating materials, such as tantalum or tantalum nitride. Passivating layers on the heater element 10 minimize corrosion of the and improve heater longevity.

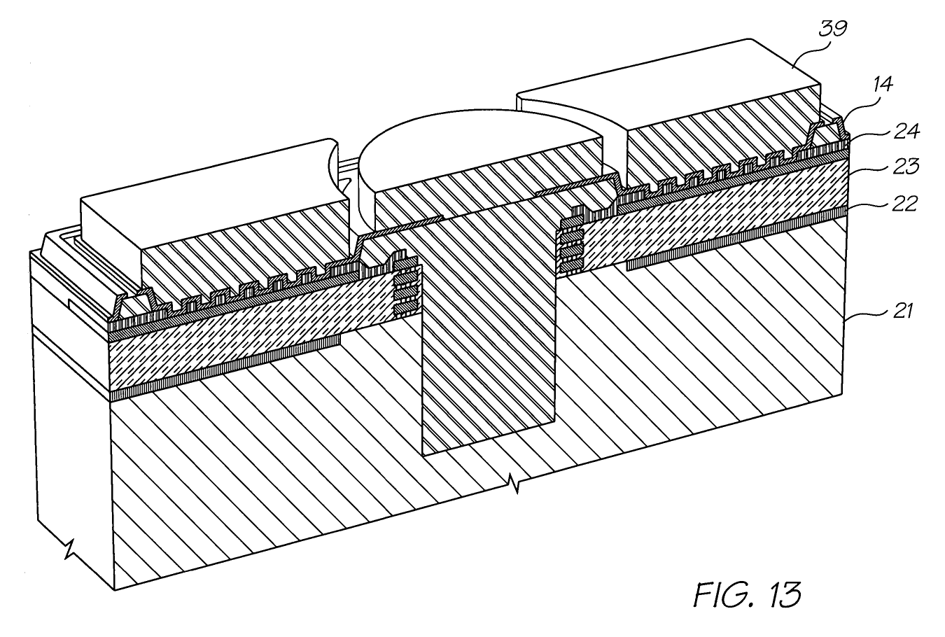

Referring to FIG. 12, the heater material 38 is subsequently etched down to the first sacrificial scaffold 54 to define the heater element 10. At the same time, contact electrodes 15 are defined on either side of the heater element 10. The electrodes 15 are in contact with the top metal layer 26 and so provide electrical connection between the CMOS and the heater element 10. The sloped side faces of the first sacrificial scaffold 54 ensure good electrical connection between the heater element 10 and the electrodes 15, since the heater material is deposited with sufficient thickness around the scaffold 54. Any thin areas of heater material (due to insufficient side face deposition) would increase resistivity and affect heater performance.

Adjacent unit cells are electrically insulated from each other by virtue of grooves etched around the perimeter of each unit cell. The grooves are etched at the same time as defining the heater element 10.

Referring to FIG. 13, in the subsequent step a second sacrificial scaffold 39 of photoresist is deposited over the heater material. The second sacrificial scaffold 39 is exposed and developed to define sidewalls for the cylindrical nozzle chamber and perimeter sidewalls for each unit cell. The second sacrificial scaffold 39 is also UV cured and hardbaked to prevent any reflow of the photoresist during subsequent high-temperature deposition of the silicon nitride roof material.

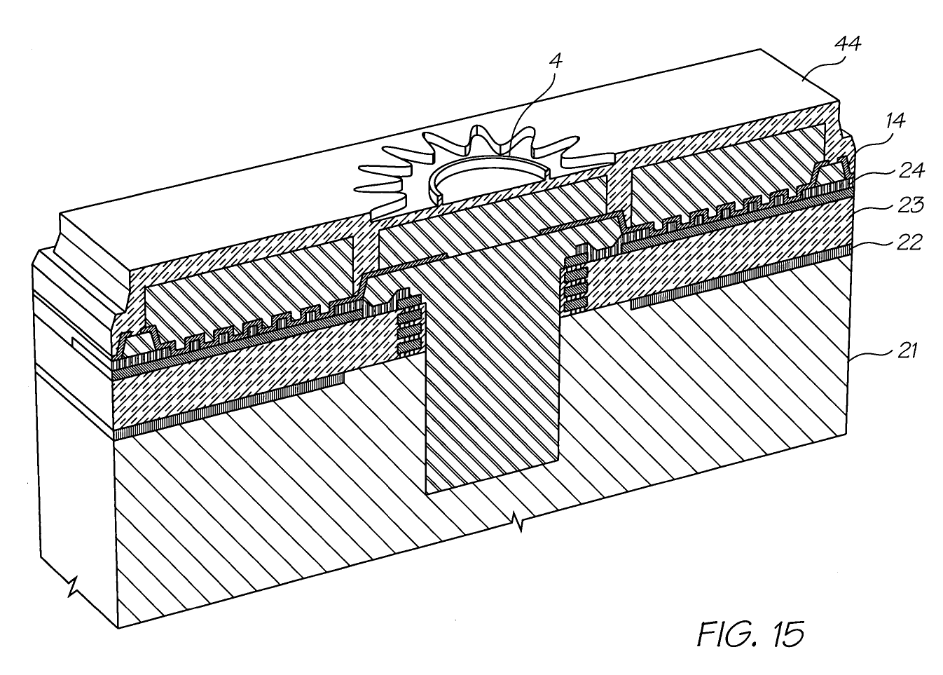

Referring to FIG. 14, silicon nitride is deposited onto the second sacrificial scaffold 39 by plasma enhanced chemical vapour deposition. The silicon nitride forms a roof 44 over each unit cell, which is the nozzle plate 2 for a row of nozzles. Chamber sidewalls 6 and unit cell sidewalls 56 are also formed by deposition of silicon nitride.

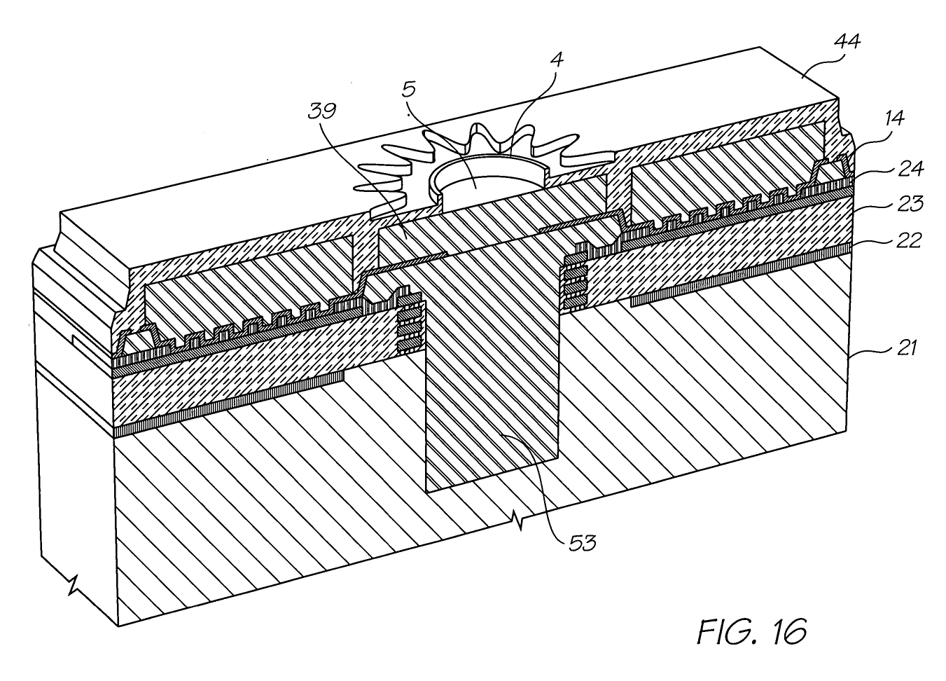

Referring to FIG. 15, the nozzle rim 4 is etched partially through the roof 44, by placing a suitably patterned photoresist mask over the roof, etching for a controlled period of time and removing the photoresist by ashing.

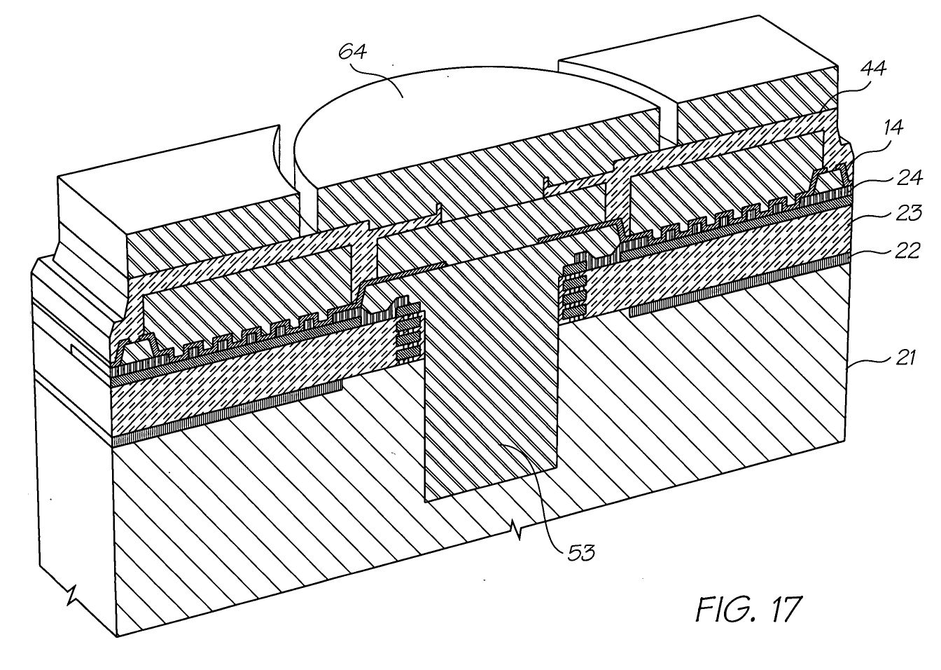

Referring to FIG. 16, the nozzle aperture 5 is etched through the roof 24 down to the second sacrificial scaffold 39. Again, the etch is performed by placing a suitably patterned photoresist mask over the roof, etching down to the scaffold 39 and removing the photoresist mask.

Referring to FIG. 17, in the next stage a third sacrificial scaffold 64 is deposited over the roof 44. The third sacrificial scaffold 64 is exposed and developed to define sidewalls for the cylindrical nozzle enclosure over each aperture 5. The third sacrificial scaffold 64 is also UV cured and hardbaked to prevent any reflow of the photoresist during subsequent high-temperature deposition of the nozzle enclosure material.

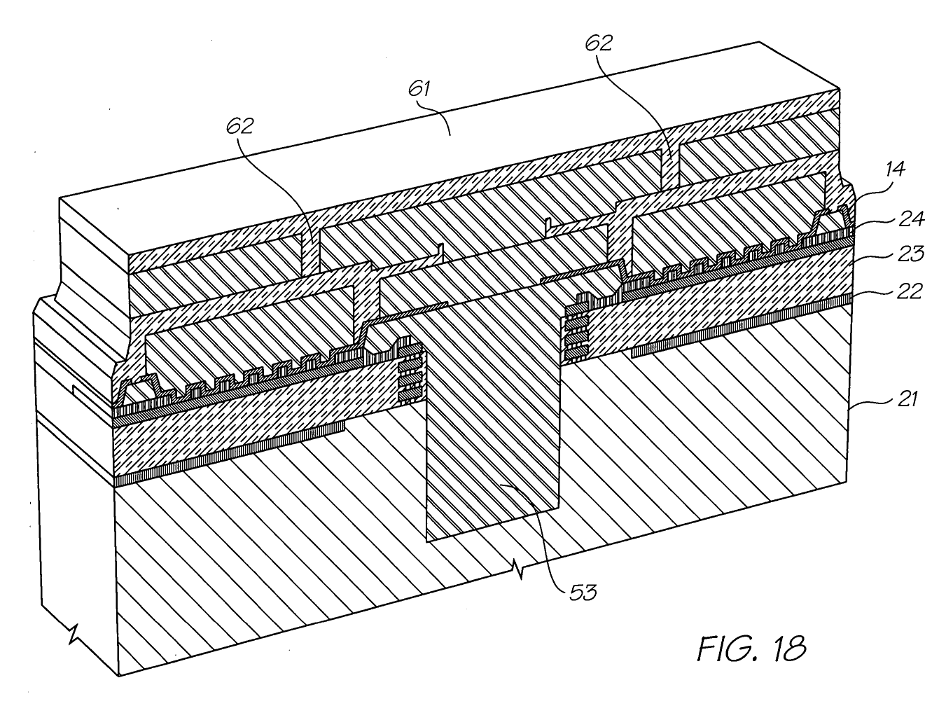

Referring to FIG. 18, silicon nitride is deposited onto the third sacrificial scaffold 64 by plasma enhanced chemical vapour deposition. The silicon nitride forms an enclosure roof 61 over each aperture 5. Enclosure sidewalls 62 are also formed by deposition of silicon nitride. Whilst silicon nitride is deposited in the embodiment shown, the enclosure roof 61 may equally be formed from silicon oxide, silicon oxynitride etc. Optionally, a layer of hydrophobic material (e.g. fluoropolymer) is deposited onto the enclosure roof 61 after deposition. This extra deposition step may be performed at any stage after deposition (e.g. after etching or after ashing).

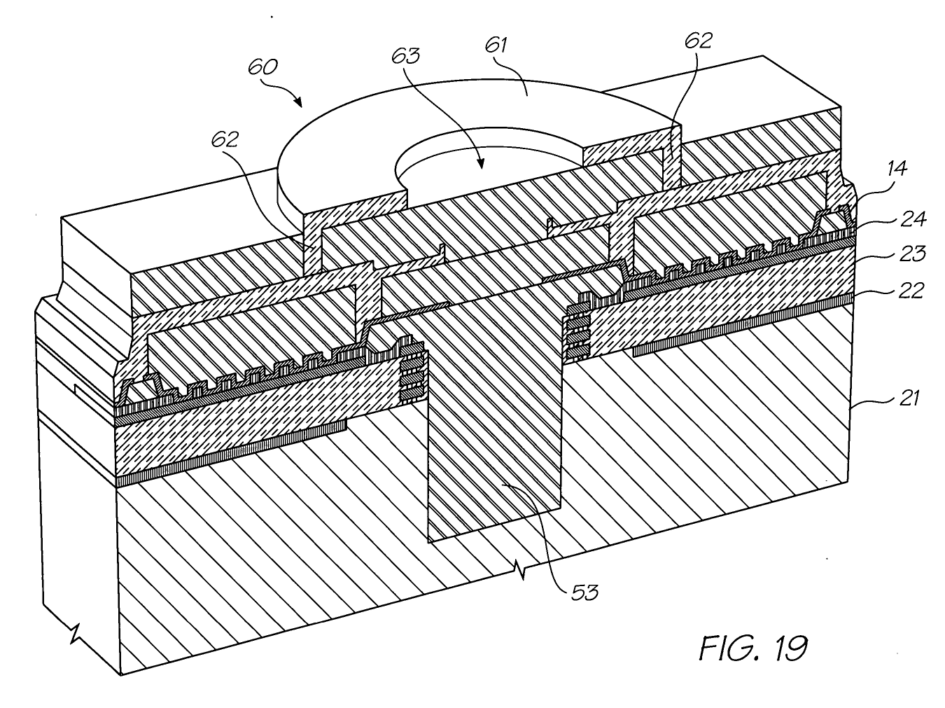

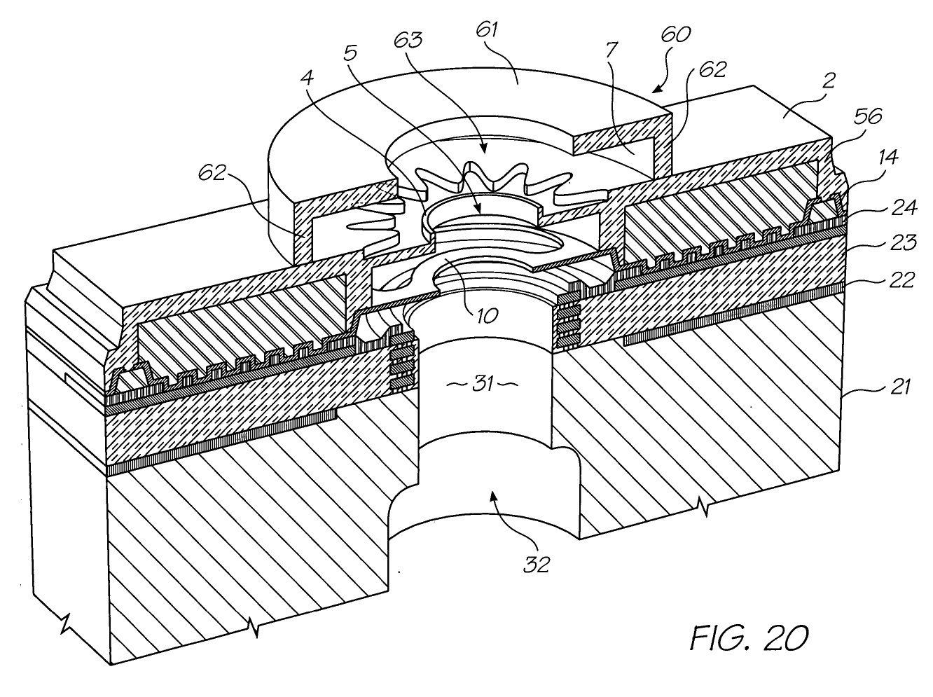

Referring to FIG. 19, the nozzle enclosure 60 is formed by etching through the enclosure roof layer 61. The enclosure opening 63 is defined by this etch. In addition, the enclosure roof material which is located outside the enclosure sidewalls 62 is removed. The etch pattern is defined by standard photoresist masking.

With the nozzle structure, including nozzle enclosure 60, now fully formed on a frontside of the silicon substrate 21, an ink supply channel 32 is etched from the backside of the substrate 21, which meets with the front plug 53.

Referring to FIG. 20, after formation of the ink supply channel 32, the first, second and sacrificial scaffolds of photoresist, together with the front plug 53 are ashed off using an O₂ plasma. Accordingly, fluid connection is made from the ink supply channel 32 through to the nozzle aperture 5 and the nozzle enclosure opening 63.

It should be noted that a portion of photoresist, on either side of the nozzle chamber sidewalls 6, remains encapsulated by the roof 44, the unit cell sidewalls 56 and the chamber sidewalls 6. This portion of photoresist is sealed from the O₂ ashing plasma and, therefore, remains intact after fabrication of the printhead. This encapsulated photoresist advantageously provides additional robustness for the printhead by supporting the nozzle plate 2. Hence, the printhead has a robust nozzle plate spanning continuously over rows of nozzles, and being supported by solid blocks of hardened photoresist, in addition to support walls.

### Other Embodiments

The invention has been described above with reference to printheads using bubble forming heater elements. However, it is potentially suited to a wide range of printing system including: color and monochrome office printers, short run digital printers, high speed digital printers, offset press supplemental printers, low cost scanning printers high speed pagewidth printers, notebook computers with inbuilt pagewidth printers, portable color and monochrome printers, color and monochrome copiers, color and monochrome facsimile machines, combined printer, facsimile and copying machines, label printers, large format plotters, photograph copiers, printers for digital photographic “minilabs”, video printers, PHOTO CD (PHOTO CD is a registered trade mark of the Eastman Kodak Company) printers, portable printers for PDAs, wallpaper printers, indoor sign printers, billboard printers, fabric printers, camera printers and fault tolerant commercial printer arrays.

It will be appreciated by ordinary workers in this field that numerous variations and/or modifications may be made to the present invention as shown in the specific embodiments without departing from the spirit or scope of the invention as broadly described. The present embodiments are, therefore, to be considered in all respects to be illustrative and not restrictive.

Ink Jet Technologies

The embodiments of the invention use an ink jet printer type device. Of course many different devices could be used. However presently popular ink jet printing technologies are unlikely to be suitable.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. In conventional thermal inkjet printheads, this leads to an efficiency of around 0.02%, from electricity input to drop momentum (and increased surface area) out.

The most significant problem with piezoelectric ink jet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty-five different ink jet technologies have been developed by the Assignee to give a wide range of choices for high volume manufacture. These technologies form part of separate applications assigned to the present Assignee as set out in the table under the heading Cross References to Related Applications.

The ink jet designs shown here are suitable for a wide range of digital printing systems, from battery powered one-time use digital cameras, through to desktop and network printers, and through to commercial printing systems.

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest printhead designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The printhead is connected to the camera circuitry by tape automated bonding.

Tables of Drop-on-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of ink jet nozzle. While not all of the possible combinations result in a viable ink jet technology, many million configurations are viable. It is clearly impractical to elucidate all of the possible configurations. Instead, certain ink jet types have been investigated in detail. These are designated IJ01 to IJ45 above which matches the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet printheads with characteristics superior to any currently available ink jet technology.

Where there are prior art examples known to the inventor, one or more of these examples are listed in the examples column of the tables below. The IJ01 to IJ45 series are also listed in the examples column. In some cases, print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

| | | | |
|---|---|---|---|
| Description | Advantages | Disadvantages | Examples |

ACTUATOR MECHANISM (APPLIED ONLY TO SELECTED INK DROPS)

| | | | | |
|---|---|---|---|---|
| Thermal | An electrothermal | Large force | High power | Canon Bubblejet |
| bubble | heater heats the ink to | generated | Ink carrier | 1979 Endo et al GB |
| | above boiling point, | Simple | limited to water | patent 2,007,162 |
| | transferring significant | construction | Low efficiency | Xerox heater-in- |
| | heat to the aqueous | No moving parts | High | pit 1990 Hawkins et |
| | ink. A bubble | Fast operation | temperatures | al U.S. Pat. No. 4,899,181 |
| | nucleates and quickly | Small chip area | required | Hewlett-Packard |
| | forms, expelling the | required for actuator | High mechanical | TIJ 1982 Vaught et |
| | ink. | | stress | al U.S. Pat. No. 4,490,728 |
| | The efficiency of the | | Unusual | |
| | process is low, with | | materials required | |
| | typically less than | | Large drive | |
| | 0.05% of the electrical | | transistors | |
| | energy being | | Cavitation causes | |
| | transformed into | | actuator failure | |
| | kinetic energy of the | | Kogation reduces | |
| | drop. | | bubble formation | |
| | | | Large print heads | |
| | | | are difficult to | |
| | | | fabricate | |
| Piezoelectric | A piezoelectric crystal | Low power | Very large area | Kyser et al U.S. Pat. No. |
| | such as lead | consumption | required for actuator | 3,946,398 |
| | lanthanum zirconate | Many ink types | Difficult to | Zoltan U.S. Pat. No. |
| | (PZT) is electrically | can be used | integrate with | 3,683,212 |
| | activated, and either | Fast operation | electronics | 1973 Stemme |
| | expands, shears, or | High efficiency | High voltage | U.S. Pat. No. 3,747,120 |
| | bends to apply | | drive transistors | Epson Stylus |
| | pressure to the ink, | | required | Tektronix |
| | ejecting drops. | | Full pagewidth | IJ04 |
| | | | print heads | |
| | | | impractical due to | |
| | | | actuator size | |
| | | | Requires | |
| | | | electrical poling in | |
| | | | high field strengths | |
| | | | during manufacture | |
| Electrostrictive | An electric field is | Low power | Low maximum | Seiko Epson, |
| | used to activate | consumption | strain (approx. | Usui et all JP |
| | electrostriction in | Many ink types | 0.01%) | 253401/96 |
| | relaxor materials such | can be used | Large area | IJ04 |
| | as lead lanthanum | Low thermal | required for actuator | |
| | zirconate titanate | expansion | due to low strain | |
| | (PLZT) or lead | Electric field | Response speed | |
| | magnesium niobate | strength required | is marginal (˜10 μs) | |
| | (PMN). | (approx. 3.5 V/μm) | High voltage | |
| | | can be generated | drive transistors | |
| | | without difficulty | required | |
| | | Does not require | Full pagewidth | |
| | | electrical poling | print heads | |
| | | | impractical due to | |
| | | | actuator size | |
| Ferroelectric | An electric field is | Low power | Difficult to | IJ04 |
| | used to induce a phase | consumption | integrate with | |
| | transition between the | Many ink types | electronics | |
| | antiferroelectric (AFE) | can be used | Unusual | |
| | and ferroelectric (FE) | Fast operation | materials such as | |
| | phase. Perovskite | (<1 μs) | PLZSnT are | |
| | materials such as tin | Relatively high | required | |
| | modified lead | longitudinal strain | Actuators require | |
| | lanthanum zirconate | High efficiency | a large area | |
| | titanate (PLZSnT) | Electric field | | |
| | exhibit large strains of | strength of around 3 V/μm | | |
| | up to 1% associated | can be readily | | |
| | with the AFE to FE | provided | | |
| | phase transition. | | | |
| Electrostatic | Conductive plates are | Low power | Difficult to | IJ02, IJ04 |
| plates | separated by a | consumption | operate electrostatic | |
| | compressible or fluid | Many ink types | devices in an | |
| | dielectric (usually air). | can be used | aqueous | |
| | Upon application of a | Fast operation | environment | |
| | voltage, the plates | | The electrostatic | |
| | attract each other and | | actuator will | |
| | displace ink, causing | | normally need to be | |
| | drop ejection. The | | separated from the | |
| | conductive plates may | | ink | |
| | be in a comb or | | Very large area | |
| | honeycomb structure, | | required to achieve | |
| | or stacked to increase | | high forces | |
| | the surface area and | | High voltage | |
| | therefore the force. | | drive transistors | |
| | | | may be required | |
| | | | Full pagewidth | |
| | | | print heads are not | |
| | | | competitive due to | |
| | | | actuator size | |
| Electrostatic | A strong electric field | Low current | High voltage | 1989 Saito et al, |
| pull | is applied to the ink, | consumption | required | U.S. Pat. No. 4,799,068 |
| on ink | whereupon | Low temperature | May be damaged | 1989 Miura et al, |
| | electrostatic attraction | | by sparks due to air | U.S. Pat. No. 4,810,954 |
| | accelerates the ink | | breakdown | Tone-jet |
| | towards the print | | Required field | |
| | medium. | | strength increases as | |
| | | | the drop size | |
| | | | decreases | |
| | | | High voltage | |
| | | | drive transistors | |
| | | | required | |
| | | | Electrostatic field | |
| | | | attracts dust | |
| Permanent | An electromagnet | Low power | Complex | IJ07, IJ10 |
| magnet | directly attracts a | consumption | fabrication | |
| electromagnetic | permanent magnet, | Many ink types | Permanent | |
| | displacing ink and | can be used | magnetic material | |
| | causing drop ejection. | Fast operation | such as Neodymium | |
| | Rare earth magnets | High efficiency | Iron Boron (NdFeB) | |
| | with a field strength | Easy extension | required. | |
| | around 1 Tesla can be | from single nozzles | High local | |
| | used. Examples are: | to pagewidth print | currents required | |
| | Samarium Cobalt | heads | Copper | |
| | (SaCo) and magnetic | | metalization should | |
| | materials in the | | be used for long | |
| | neodymium iron boron | | electromigration | |
| | family (NdFeB, | | lifetime and low | |
| | NdDyFeBNb, | | resistivity | |
| | NdDyFeB, etc) | | Pigmented inks | |
| | | | are usually | |
| | | | infeasible | |
| | | | Operating | |
| | | | temperature limited | |
| | | | to the Curie | |
| | | | temperature (around | |
| | | | 540 K) | |
| Soft | A solenoid induced a | Low power | Complex | IJ01, IJ05, IJ08, |
| magnetic | magnetic field in a soft | consumption | fabrication | IJ10, IJ12, IJ14, |
| core electromagnetic | magnetic core or yoke | Many ink types | Materials not | IJ15, IJ17 |
| | fabricated from a | can be used | usually present in a | |
| | ferrous material such | Fast operation | CMOS fab such as | |
| | as electroplated iron | High efficiency | NiFe, CoNiFe, or | |
| | alloys such as CoNiFe | Easy extension | CoFe are required | |
| | [1], CoFe, or NiFe | from single nozzles | High local | |
| | alloys. Typically, the | to pagewidth print | currents required | |
| | soft magnetic material | heads | Copper | |
| | is in two parts, which | | metalization should | |
| | are normally held | | be used for long | |
| | apart by a spring. | | electromigration | |
| | When the solenoid is | | lifetime and low | |
| | actuated, the two parts | | resistivity | |
| | attract, displacing the | | Electroplating is | |
| | ink. | | required | |
| | | | High saturation | |
| | | | flux density is | |
| | | | required (2.0-2.1 T | |
| | | | is achievable with | |
| | | | CoNiFe [1]) | |
| Lorenz | The Lorenz force | Low power | Force acts as a | IJ06, IJ11, IJ13, |
| force | acting on a current | consumption | twisting motion | IJ16 |
| | carrying wire in a | Many ink types | Typically, only a | |
| | magnetic field is | can be used | quarter of the | |
| | utilized. | Fast operation | solenoid length | |
| | This allows the | High efficiency | provides force in a | |
| | magnetic field to be | Easy extension | useful direction | |
| | supplied externally to | from single nozzles | High local | |
| | the print head, for | to pagewidth print | currents required | |
| | example with rare | heads | Copper | |
| | earth permanent | | metalization should | |
| | magnets. | | be used for long | |
| | Only the current | | electromigration | |
| | carrying wire need be | | lifetime and low | |
| | fabricated on the print- | | resistivity | |
| | head, simplifying | | Pigmented inks | |
| | materials | | are usually | |
| | requirements. | | infeasible | |
| Magnetostriction | The actuator uses the | Many ink types | Force acts as a | Fischenbeck, |
| | giant magnetostrictive | can be used | twisting motion | U.S. Pat. No. 4,032,929 |
| | effect of materials | Fast operation | Unusual | IJ25 |
| | such as Terfenol-D (an | Easy extension | materials such as | |
| | alloy of terbium, | from single nozzles | Terfenol-D are | |
| | dysprosium and iron | to pagewidth print | required | |
| | developed at the Naval | heads | High local | |
| | Ordnance Laboratory, | High force is | currents required | |
| | hence Ter-Fe-NOL). | available | Copper | |
| | For best efficiency, the | | metalization should | |
| | actuator should be pre- | | be used for long | |
| | stressed to approx. 8 MPa. | | electromigration | |
| | | | lifetime and low | |
| | | | resistivity | |
| | | | Pre-stressing | |
| | | | may be required | |
| Surface | Ink under positive | Low power | Requires | Silverbrook, EP |
| tension | pressure is held in a | consumption | supplementary force | 0771 658 A2 and |
| reduction | nozzle by surface | Simple | to effect drop | related patent |
| | tension. The surface | construction | separation | applications |
| | tension of the ink is | No unusual | Requires special | |
| | reduced below the | materials required in | ink surfactants | |
| | bubble threshold, | fabrication | Speed may be | |
| | causing the ink to | High efficiency | limited by surfactant | |
| | egress from the | Easy extension | properties | |
| | nozzle. | from single nozzles | | |
| | | to pagewidth print | | |
| | | heads | | |
| Viscosity | The ink viscosity is | Simple | Requires | Silverbrook, EP |
| reduction | locally reduced to | construction | supplementary force | 0771 658 A2 and |
| | select which drops are | No unusual | to effect drop | related patent |
| | to be ejected. A | materials required in | separation | applications |
| | viscosity reduction can | fabrication | Requires special | |
| | be achieved | Easy extension | ink viscosity | |
| | electrothermally with | from single nozzles | properties | |
| | most inks, but special | to pagewidth print | High speed is | |
| | inks can be engineered | heads | difficult to achieve | |
| | for a 100:1 viscosity | | Requires | |
| | reduction. | | oscillating ink | |
| | | | pressure | |
| | | | A high | |
| | | | temperature | |
| | | | difference (typically | |
| | | | 80 degrees) is | |
| | | | required | |
| Acoustic | An acoustic wave is | Can operate | Complex drive | 1993 Hadimioglu |
| | generated and | without a nozzle | circuitry | et al, EUP 550,192 |
| | focussed upon the | plate | Complex | 1993 Elrod et al, |
| | drop ejection region. | | fabrication | EUP 572,220 |
| | | | Low efficiency | |
| | | | Poor control of | |
| | | | drop position | |
| | | | Poor control of | |
| | | | drop volume | |
| Thermo- | An actuator which | Low power | Efficient aqueous | IJ03, IJ09, IJ17, |
| elastic bend | relies upon differential | consumption | operation requires a | IJ18, IJ19, IJ20, |
| actuator | thermal expansion | Many ink types | thermal insulator on | IJ21, IJ22, IJ23, |
| | upon Joule heating is | can be used | the hot side | IJ24, IJ27, IJ28, |
| | used. | Simple planar | Corrosion | IJ29, IJ30, IJ31, |
| | | fabrication | prevention can be | IJ32, IJ33, IJ34, |
| | | Small chip area | difficult | IJ35, IJ36, IJ37, |
| | | required for each | Pigmented inks | IJ38, IJ39, IJ40, |
| | | actuator | may be infeasible, | IJ41 |
| | | Fast operation | as pigment particles | |
| | | High efficiency | may jam the bend | |
| | | CMOS | actuator | |
| | | compatible voltages | | |
| | | and currents | | |
| | | Standard MEMS | | |
| | | processes can be | | |
| | | used | | |
| | | Easy extension | | |
| | | from single nozzles | | |
| | | to pagewidth print | | |
| | | heads | | |
| High CTE | A material with a very | High force can | Requires special | IJ09, IJ17, IJ18, |
| thermo- | high coefficient of | be generated | material (e.g. PTFE) | IJ20, IJ21, IJ22, |
| elastic | thermal expansion | Three methods of | Requires a PTFE | IJ23, IJ24, IJ27, |
| actuator | (CTE) such as | PTFE deposition are | deposition process, | IJ28, IJ29, IJ30, |
| | polytetrafluoroethylene | under development: | which is not yet | IJ31, IJ42, IJ43, |
| | (PTFE) is used. As | chemical vapor | standard in ULSI | IJ44 |
| | high CTE materials | deposition (CVD), | fabs | |
| | are usually non- | spin coating, and | PTFE deposition | |
| | conductive, a heater | evaporation | cannot be followed | |
| | fabricated from a | PTFE is a | with high | |
| | conductive material is | candidate for low | temperature (above | |
| | incorporated. A 50 μm | dielectric constant | 350° C.) processing | |
| | long PTFE bend | insulation in ULSI | Pigmented inks | |
| | actuator with | Very low power | may be infeasible, | |
| | polysilicon heater and | consumption | as pigment particles | |
| | 15 mW power input | Many ink types | may jam the bend | |
| | can provide 180 μN | can be used | actuator | |
| | force and 10 μm | Simple planar | | |
| | deflection. Actuator | fabrication | | |
| | motions include: | Small chip area | | |
| | Bend | required for each | | |
| | Push | actuator | | |
| | Buckle | Fast operation | | |
| | Rotate | High efficiency | | |
| | | CMOS | | |
| | | compatible voltages | | |
| | | and currents | | |
| | | Easy extension | | |
| | | from single nozzles | | |
| | | to pagewidth print | | |
| | | heads | | |
| Conduct-ive | A polymer with a high | High force can | Requires special | IJ24 |
| polymer | coefficient of thermal | be generated | materials | |
| thermo- | expansion (such as | Very low power | development (High | |
| elastic | PTFE) is doped with | consumption | CTE conductive | |
| actuator | conducting substances | Many ink types | polymer) | |
| | to increase its | can be used | Requires a PTFE | |
| | conductivity to about 3 | Simple planar | deposition process, | |
| | orders of magnitude | fabrication | which is not yet | |
| | below that of copper. | Small chip area | standard in ULSI | |
| | The conducting | required for each | fabs | |
| | polymer expands | actuator | PTFE deposition | |
| | when resistively | Fast operation | cannot be followed | |
| | heated. | High efficiency | with high | |
| | Examples of | CMOS | temperature (above | |
| | conducting dopants | compatible voltages | 350° C.) processing | |
| | include: | and currents | Evaporation and | |
| | Carbon nanotubes | Easy extension | CVD deposition | |
| | Metal fibers | from single nozzles | techniques cannot | |
| | Conductive polymers | to pagewidth print | be used | |
| | such as doped | heads | Pigmented inks | |
| | polythiophene | | may be infeasible, | |
| | Carbon granules | | as pigment particles | |
| | | | may jam the bend | |
| | | | actuator | |
| Shape | A shape memory alloy | High force is | Fatigue limits | IJ26 |
| memory | such as TiNi (also | available (stresses | maximum number | |
| alloy | known as Nitinol — | of hundreds of MPa) | of cycles | |
| | Nickel Titanium alloy | Large strain is | Low strain (1%) | |
| | developed at the Naval | available (more than | is required to extend | |
| | Ordnance Laboratory) | 3%) | fatigue resistance | |
| | is thermally switched | High corrosion | Cycle rate | |
| | between its weak | resistance | limited by heat | |
| | martensitic state and | Simple | removal | |
| | its high stiffness | construction | Requires unusual | |
| | austenic state. The | Easy extension | materials (TiNi) | |
| | shape of the actuator | from single nozzles | The latent heat of | |
| | in its martensitic state | to pagewidth print | transformation must | |
| | is deformed relative to | heads | be provided | |
| | the austenic shape. | Low voltage | High current | |
| | The shape change | operation | operation | |
| | causes ejection of a | | Requires pre- | |
| | drop. | | stressing to distort | |
| | | | the martensitic state | |
| Linear | Linear magnetic | Linear Magnetic | Requires unusual | IJ12 |
| Magnetic | actuators include the | actuators can be | semiconductor | |
| Actuator | Linear Induction | constructed with | materials such as | |
| | Actuator (LIA), Linear | high thrust, long | soft magnetic alloys | |
| | Permanent Magnet | travel, and high | (e.g. CoNiFe) | |
| | Synchronous Actuator | efficiency using | Some varieties | |
| | (LPMSA), Linear | planar | also require | |
| | Reluctance | semiconductor | permanent magnetic | |
| | Synchronous Actuator | fabrication | materials such as | |
| | (LRSA), Linear | techniques | Neodymium iron | |
| | Switched Reluctance | Long actuator | boron (NdFeB) | |
| | Actuator (LSRA), and | travel is available | Requires | |
| | the Linear Stepper | Medium force is | complex multiphase | |
| | Actuator (LSA). | available | drive circuitry | |
| | | Low voltage | High current | |
| | | operation | operation | |

BASIC OPERATION MODE

| | | | | |
|---|---|---|---|---|
| Actuator | This is the simplest | Simple operation | Drop repetition | Thermal ink jet |
| directly | mode of operation: the | No external | rate is usually | Piezoelectric ink |
| pushes ink | actuator directly | fields required | limited to around 10 kHz. | jet |
| | supplies sufficient | Satellite drops | However, this | IJ01, IJ02, IJ03, |
| | kinetic energy to expel | can be avoided if | is not fundamental | IJ04, IJ05, IJ06, |
| | the drop. The drop | drop velocity is less | to the method, but is | IJ07, IJ09, IJ11, |
| | must have a sufficient | than 4 m/s | related to the refill | IJ12, IJ14, IJ16, |
| | velocity to overcome | Can be efficient, | method normally | IJ20, IJ22, IJ23, |
| | the surface tension. | depending upon the | used | IJ24, IJ25, IJ26, |
| | | actuator used | All of the drop | IJ27, IJ28, IJ29, |
| | | | kinetic energy must | IJ30, IJ31, IJ32, |
| | | | be provided by the | IJ33, IJ34, IJ35, |
| | | | actuator | IJ36, IJ37, IJ38, |
| | | | Satellite drops | IJ39, IJ40, IJ41, |
| | | | usually form if drop | IJ42, IJ43, IJ44 |
| | | | velocity is greater | |
| | | | than 4.5 m/s | |

BASIC OPERATION MODE

| | Description | Advantages | Disadvantages | Examples |
|---|---|---|---|---|
| Proximity | The drops to be | Very simple print | Requires close | Silverbrook, EP |
| | printed are selected by | head fabrication can | proximity between | 0771 658 A2 and |
| | some manner (e.g. | be used | the print head and | related patent |
| | thermally induced | The drop | the print media or | applications |
| | surface tension | selection means | transfer roller | |
| | reduction of | does not need to | May require two | |
| | pressurized ink). | provide the energy | print heads printing | |
| | Selected drops are | required to separate | alternate rows of the | |
| | separated from the ink | the drop from the | image | |
| | in the nozzle by | nozzle | Monolithic color | |
| | contact with the print | | print heads are | |
| | medium or a transfer | | difficult | |
| | roller. | | | |
| Electrostatic | The drops to be | Very simple print | Requires very | Silverbrook, EP |
| pull | printed are selected by | head fabrication can | high electrostatic | 0771 658 A2 and |
| on ink | some manner (e.g. | be used | field | related patent |
| | thermally induced | The drop | Electrostatic field | applications |
| | surface tension | selection means | for small nozzle | Tone-Jet |
| | reduction of | does not need to | sizes is above air | |
| | pressurized ink). | provide the energy | breakdown | |
| | Selected drops are | required to separate | Electrostatic field | |
| | separated from the ink | the drop from the | may attract dust | |
| | in the nozzle by a | nozzle | | |
| | strong electric field. | | | |
| Magnetic | The drops to be | Very simple print | Requires | Silverbrook, EP |
| pull on ink | printed are selected by | head fabrication can | magnetic ink | 0771 658 A2 and |
| | some manner (e.g. | be used | Ink colors other | related patent |
| | thermally induced | The drop | than black are | applications |
| | surface tension | selection means | difficult | |
| | reduction of | does not need to | Requires very | |
| | pressurized ink). | provide the energy | high magnetic fields | |
| | Selected drops are | required to separate | | |
| | separated from the ink | the drop from the | | |
| | in the nozzle by a | nozzle | | |
| | strong magnetic field | | | |
| | acting on the magnetic | | | |
| | ink. | | | |
| Shutter | The actuator moves a | High speed (>50 kHz) | Moving parts are | IJ13, IJ17, IJ21 |
| | shutter to block ink | operation can | required | |
| | flow to the nozzle. The | be achieved due to | Requires ink | |
| | ink pressure is pulsed | reduced refill time | pressure modulator | |
| | at a multiple of the | Drop timing can | Friction and wear | |
| | drop ejection | be very accurate | must be considered | |
| | frequency. | The actuator | Stiction is | |
| | | energy can be very | possible | |
| | | low | | |
| Shuttered | The actuator moves a | Actuators with | Moving parts are | IJ08, IJ15, IJ18, |
| grill | shutter to block ink | small travel can be | required | IJ19 |
| | flow through a grill to | used | Requires ink | |
| | the nozzle. The shutter | Actuators with | pressure modulator | |
| | movement need only | small force can be | Friction and wear | |
| | be equal to the width | used | must be considered | |
| | of the grill holes. | High speed (>50 kHz) | Stiction is | |
| | | operation can | possible | |
| | | be achieved | | |
| Pulsed | A pulsed magnetic | Extremely low | Requires an | IJ10 |
| magnetic | field attracts an ‘ink | energy operation is | external pulsed | |
| pull on ink | pusher’ at the drop | possible | magnetic field | |
| pusher | ejection frequency. An | No heat | Requires special | |
| | actuator controls a | dissipation | materials for both | |
| | catch, which prevents | problems | the actuator and the | |
| | the ink pusher from | | ink pusher | |
| | moving when a drop is | | Complex | |
| | not to be ejected. | | construction | |

AUXILIARY MECHANISM (APPLIED TO ALL NOZZLES)

| | Description | Advantages | Disadvantages | Examples |
|---|---|---|---|---|
| None | The actuator directly | Simplicity of | Drop ejection | Most ink jets, |
| | fires the ink drop, and | construction | energy must be | including |
| | there is no external | Simplicity of | supplied by | piezoelectric and |
| | field or other | operation | individual nozzle | thermal bubble. |
| | mechanism required. | Small physical | actuator | IJ01, IJ02, IJ03, |
| | | size | | IJ04, IJ05, IJ07, |
| | | | | IJ09, IJ11, IJ12, |
| | | | | IJ14, IJ20, IJ22, |
| | | | | IJ23, IJ24, IJ25, |
| | | | | IJ26, IJ27, IJ28, |
| | | | | IJ29, IJ30, IJ31, |
| | | | | IJ32, IJ33, IJ34, |
| | | | | IJ35, IJ36, IJ37, |
| | | | | IJ38, IJ39, IJ40, |
| | | | | IJ41, IJ42, IJ43, |
| | | | | IJ44 |
| Oscillating | The ink pressure | Oscillating ink | Requires external | Silverbrook, EP |
| ink pressure | oscillates, providing | pressure can provide | ink pressure | 0771 658 A2 and |
| (including | much of the drop | a refill pulse, | oscillator | related patent |
| acoustic | ejection energy. The | allowing higher | Ink pressure | applications |
| stimulation) | actuator selects which | operating speed | phase and amplitude | IJ08, IJ13, IJ15, |
| | drops are to be fired | The actuators | must be carefully | IJ17, IJ18, IJ19, |
| | by selectively | may operate with | controlled | IJ21 |
| | blocking or enabling | much lower energy | Acoustic | |
| | nozzles. The ink | Acoustic lenses | reflections in the ink | |
| | pressure oscillation | can be used to focus | chamber must be | |
| | may be achieved by | the sound on the | designed for | |
| | vibrating the print | nozzles | | |
| | head, or preferably by | | | |
| | an actuator in the ink | | | |
| | supply. | | | |
| Media | The print head is | Low power | Precision | Silverbrook, EP |
| proximity | placed in close | High accuracy | assembly required | 0771 658 A2 and |
| | proximity to the print | Simple print head | Paper fibers may | related patent |
| | medium. Selected | construction | cause problems | applications |
| | drops protrude from | | Cannot print on | |
| | the print head further | | rough substrates | |
| | than unselected drops, | | | |
| | and contact the print | | | |
| | medium. The drop | | | |
| | soaks into the medium | | | |
| | fast enough to cause | | | |
| | drop separation. | | | |
| Transfer | Drops are printed to a | High accuracy | Bulky | Silverbrook, EP |
| roller | transfer roller instead | Wide range of | Expensive | 0771 658 A2 and |
| | of straight to the print | print substrates can | Complex | related patent |
| | medium. A transfer | be used | construction | applications |
| | roller can also be used | Ink can be dried | | Tektronix hot |
| | for proximity drop | on the transfer roller | | melt piezoelectric |
| | separation. | | | ink jet |
| | | | | Any of the IJ |
| | | | | series |
| Electrostatic | An electric field is | Low power | Field strength | Silverbrook, EP |
| | used to accelerate | Simple print head | required for | 0771 658 A2 and |
| | selected drops towards | construction | separation of small | related patent |
| | the print medium. | | drops is near or | applications |
| | | | above air | Tone-Jet |
| | | | breakdown | |
| Direct | A magnetic field is | Low power | Requires | Silverbrook, EP |
| magnetic | used to accelerate | Simple print head | magnetic ink | 0771 658 A2 and |
| field | selected drops of | construction | Requires strong | related patent |
| | magnetic ink towards | | magnetic field | applications |
| | the print medium. | | | |
| Cross | The print head is | Does not require | Requires external | IJ06, IJ16 |
| magnetic | placed in a constant | magnetic materials | magnet | |
| field | magnetic field. The | to be integrated in | Current densities | |
| | Lorenz force in a | the print head | may be high, | |
| | current carrying wire | manufacturing | resulting in | |
| | is used to move the | process | electromigration | |
| | actuator. | | problems | |
| Pulsed | A pulsed magnetic | Very low power | Complex print | IJ10 |
| magnetic | field is used to | operation is possible | head construction | |
| field | cyclically attract a | Small print head | Magnetic | |
| | paddle, which pushes | size | materials required in | |
| | on the ink. A small | | print head | |
| | actuator moves a | | | |
| | catch, which | | | |
| | selectively prevents | | | |
| | the paddle from | | | |
| | moving. | | | |

ACTUATOR AMPLIFICATION OR MODIFICATION METHOD

| | Description | Advantages | Disadvantages | Examples |
|---|---|---|---|---|
| None | No actuator | Operational | Many actuator | Thermal Bubble |
| | mechanical | simplicity | mechanisms have | Ink jet |
| | amplification is used. | | insufficient travel, | IJ01, IJ02, IJ06, |
| | The actuator directly | | or insufficient force, | IJ07, IJ16, IJ25, |
| | drives the drop | | to efficiently drive | IJ26 |
| | ejection process. | | the drop ejection | |
| | | | process | |
| Differential | An actuator material | Provides greater | High stresses are | Piezoelectric |
| expansion | expands more on one | travel in a reduced | involved | IJ03, IJ09, IJ17, |
| bend | side than on the other. | print head area | Care must be | IJ18, IJ19, IJ20, |
| actuator | The expansion may be | | taken that the | IJ21, IJ22, IJ23, |
| | thermal, piezoelectric, | | materials do not | IJ24, IJ27, IJ29, |
| | magnetostrictive, or | | delaminate | IJ30, IJ31, IJ32, |
| | other mechanism. The | | Residual bend | IJ33, IJ34, IJ35, |
| | bend actuator converts | | resulting from high | IJ36, IJ37, IJ38, |
| | a high force low travel | | temperature or high | IJ39, IJ42, IJ43, |
| | actuator mechanism to | | stress during | IJ44 |
| | high travel, lower | | formation | |
| | force mechanism. | | | |
| Transient | A trilayer bend | Very good | High stresses are | IJ40, IJ41 |
| bend | actuator where the two | temperature stability | involved | |
| actuator | outside layers are | High speed, as a | Care must be | |
| | identical. This cancels | new drop can be | taken that the | |
| | bend due to ambient | fired before heat | materials do not | |
| | temperature and | dissipates | delaminate | |
| | residual stress. The | Cancels residual | | |
| | actuator only responds | stress of formation | | |
| | to transient heating of | | | |
| | one side or the other. | | | |
| Reverse | The actuator loads a | Better coupling | Fabrication | IJ05, IJ11 |
| spring | spring. When the | to the ink | complexity | |
| | actuator is turned off, | | High stress in the | |
| | the spring releases. | | spring | |
| | This can reverse the | | | |
| | force/distance curve of | | | |
| | the actuator to make it | | | |
| | compatible with the | | | |
| | force/time | | | |
| | requirements of the | | | |
| | drop ejection. | | | |
| Actuator | A series of thin | Increased travel | Increased | Some |
| stack | actuators are stacked. | Reduced drive | fabrication | piezoelectric ink jets |
| | This can be | voltage | complexity | IJ04 |
| | appropriate where | | Increased | |
| | actuators require high | | possibility of short | |
| | electric field strength, | | circuits due to | |
| | such as electrostatic | | pinholes | |
| | and piezoelectric | | | |
| | actuators. | | | |
| Multiple | Multiple smaller | Increases the | Actuator forces | IJ12, IJ13, IJ18, |
| actuators | actuators are used | force available from | may not add | IJ20, IJ22, IJ28, |
| | simultaneously to | an actuator | linearly, reducing | IJ42, IJ43 |
| | move the ink. Each | Multiple | efficiency | |
| | actuator need provide | actuators can be | | |
| | only a portion of the | positioned to control | | |
| | force required. | ink flow accurately | | |
| Linear | A linear spring is used | Matches low | Requires print | IJ15 |
| Spring | to transform a motion | travel actuator with | head area for the | |
| | with small travel and | higher travel | spring | |
| | high force into a | requirements | | |
| | longer travel, lower | Non-contact | | |
| | force motion. | method of motion | | |
| | | transformation | | |
| Coiled | A bend actuator is | Increases travel | Generally | IJ17, IJ21, IJ34, |
| actuator | coiled to provide | Reduces chip | restricted to planar | IJ35 |
| | greater travel in a | area | implementations | |
| | reduced chip area. | Planar | due to extreme | |
| | | implementations are | fabrication difficulty | |
| | | relatively easy to | in other orientations. | |
| | | fabricate. | | |
| Flexure | A bend actuator has a | Simple means of | Care must be | IJ10, IJ19, IJ33 |
| bend | small region near the | increasing travel of | taken not to exceed | |
| actuator | fixture point, which | a bend actuator | the elastic limit in | |
| | flexes much more | | the flexure area | |
| | readily than the | | Stress | |
| | remainder of the | | distribution is very | |
| | actuator. The actuator | | uneven | |
| | flexing is effectively | | Difficult to | |
| | converted from an | | accurately model | |
| | even coiling to an | | with finite element | |
| | angular bend, resulting | | analysis | |
| | in greater travel of the | | | |
| | actuator tip. | | | |
| Catch | The actuator controls a | Very low | Complex | IJ10 |
| | small catch. The catch | actuator energy | construction | |
| | either enables or | Very small | Requires external | |
| | disables movement of | actuator size | force | |
| | an ink pusher that is | | Unsuitable for | |
| | controlled in a bulk | | pigmented inks | |
| | manner. | | | |
| Gears | Gears can be used to | Low force, low | Moving parts are | IJ13 |
| | increase travel at the | travel actuators can | required | |
| | expense of duration. | be used | Several actuator | |
| | Circular gears, rack | Can be fabricated | cycles are required | |
| | and pinion, ratchets, | using standard | More complex | |
| | and other gearing | surface MEMS | drive electronics | |
| | methods can be used. | processes | Complex | |
| | | | construction | |
| | | | Friction, friction, | |
| | | | and wear are | |
| | | | possible | |
| Buckle plate | A buckle plate can be | Very fast | Must stay within | S. Hirata et al, |
| | used to change a slow | movement | elastic limits of the | “An Ink-jet Head |
| | actuator into a fast | achievable | materials for long | Using Diaphragm |
| | motion. It can also | | device life | Microactuator”, |
| | convert a high force, | | High stresses | Proc. IEEE MEMS, |
| | low travel actuator | | involved | February 1996, pp 418-423. |
| | into a high travel, | | Generally high | IJ18, IJ27 |
| | medium force motion. | | power requirement | |
| Tapered | A tapered magnetic | Linearizes the | Complex | IJ14 |
| magnetic | pole can increase | magnetic | construction | |
| pole | travel at the expense | force/distance curve | | |
| | of force. | | | |
| Lever | A lever and fulcrum is | Matches low | High stress | IJ32, IJ36, IJ37 |
| | used to transform a | travel actuator with | around the fulcrum | |
| | motion with small | higher travel | | |
| | travel and high force | requirements | | |
| | into a motion with | Fulcrum area has | | |
| | longer travel and | no linear movement, | | |
| | lower force. The lever | and can be used for | | |
| | can also reverse the | a fluid seal | | |
| | direction of travel. | | | |
| Rotary | The actuator is | High mechanical | Complex | IJ28 |
| impeller | connected to a rotary | advantage | construction | |
| | impeller. A small | The ratio of force | Unsuitable for | |
| | angular deflection of | to travel of the | pigmented inks | |
| | the actuator results in | actuator can be | | |
| | a rotation of the | matched to the | | |
| | impeller vanes, which | nozzle requirements | | |
| | push the ink against | by varying the | | |
| | stationary vanes and | number of impeller | | |
| | out of the nozzle. | vanes | | |
| Acoustic | A refractive or | No moving parts | Large area | 1993 Hadimioglu |
| lens | diffractive (e.g. zone | | required | et al, EUP 550,192 |
| | plate) acoustic lens is | | Only relevant for | 1993 Elrod et al, |
| | used to concentrate | | acoustic ink jets | EUP 572,220 |
| | sound waves. | | | |
| Sharp | A sharp point is used | Simple | Difficult to | Tone-jet |
| conductive | to concentrate an | construction | fabricate using | |
| point | electrostatic field. | | standard VLSI | |
| | | | processes for a | |
| | | | surface ejecting ink- | |
| | | | jet | |
| | | | Only relevant for | |
| | | | electrostatic ink jets | |

ACTUATOR MOTION

| | Description | Advantages | Disadvantages | Examples |
|---|---|---|---|---|
| Volume | The volume of the | Simple | High energy is | Hewlett-Packard |
| expansion | actuator changes, | construction in the | typically required to | Thermal Ink jet |
| | pushing the ink in all | case of thermal ink | achieve volume | Canon Bubblejet |
| | directions. | jet | expansion. This | |
| | | | leads to thermal | |
| | | | stress, cavitation, | |
| | | | and kogation in | |
| | | | thermal ink jet | |
| | | | implementations | |
| Linear, | The actuator moves in | Efficient | High fabrication | IJ01, IJ02, IJ04, |
| normal to | a direction normal to | coupling to ink | complexity may be | IJ07, IJ11, IJ14 |
| chip surface | the print head surface. | drops ejected | required to achieve | |
| | The nozzle is typically | normal to the | perpendicular | |
| | in the line of | surface | motion | |
| | movement. | | | |
| Parallel to | The actuator moves | Suitable for | Fabrication | IJ12, IJ13, IJ15, |
| chip surface | parallel to the print | planar fabrication | complexity | IJ33,, IJ34, IJ35, |
| | head surface. Drop | | Friction | IJ36 |
| | ejection may still be | | Stiction | |
| | normal to the surface. | | | |
| Membrane | An actuator with a | The effective | Fabrication | 1982 Howkins |
| push | high force but small | area of the actuator | complexity | U.S. Pat. No. 4,459,601 |
| | area is used to push a | becomes the | Actuator size | |
| | stiff membrane that is | membrane area | Difficulty of | |
| | in contact with the ink. | | integration in a | |
| | | | VLSI process | |
| Rotary | The actuator causes | Rotary levers | Device | IJ05, IJ08, IJ13, |
| | the rotation of some | may be used to | complexity | IJ28 |
| | element, such a grill or | increase travel | May have | |
| | impeller | Small chip area | friction at a pivot | |
| | | requirements | point | |
| Bend | The actuator bends | A very small | Requires the | 1970 Kyser et al |
| | when energized. This | change in | actuator to be made | U.S. Pat. No. 3,946,398 |
| | may be due to | dimensions can be | from at least two | 1973 Stemme |
| | differential thermal | converted to a large | distinct layers, or to | U.S. Pat. No. 3,747,120 |
| | expansion, | motion. | have a thermal | IJ03, IJ09, IJ10, |
| | piezoelectric | | difference across the | IJ19, IJ23, IJ24, |
| | expansion, | | actuator | IJ25, IJ29, IJ30, |
| | magnetostriction, or | | | IJ31, IJ33, IJ34, |
| | other form of relative | | | IJ35 |
| | dimensional change. | | | |
| Swivel | The actuator swivels | Allows operation | Inefficient | IJ06 |
| | around a central pivot. | where the net linear | coupling to the ink | |
| | This motion is suitable | force on the paddle | motion | |
| | where there are | is zero | | |
| | opposite forces | Small chip area | | |
| | applied to opposite | requirements | | |
| | sides of the paddle, | | | |
| | e.g. Lorenz force. | | | |
| Straighten | The actuator is | Can be used with | Requires careful | IJ26, IJ32 |
| | normally bent, and | shape memory | balance of stresses | |
| | straightens when | alloys where the | to ensure that the | |
| | energized. | austenic phase is | quiescent bend is | |
| | | planar | accurate | |
| Double | The actuator bends in | One actuator can | Difficult to make | IJ36, IJ37, IJ38 |
| bend | one direction when | be used to power | the drops ejected by | |
| | one element is | two nozzles. | both bend directions | |
| | energized, and bends | Reduced chip | identical. | |
| | the other way when | size. | A small | |
| | another element is | Not sensitive to | efficiency loss | |
| | energized. | ambient temperature | compared to | |
| | | | equivalent single | |
| | | | bend actuators. | |
| Shear | Energizing the | Can increase the | Not readily | 1985 Fishbeck |
| | actuator causes a shear | effective travel of | applicable to other | U.S. Pat. No. 4,584,590 |
| | motion in the actuator | piezoelectric | actuator | |
| | material. | actuators | mechanisms | |
| Radial constriction | The actuator squeezes | Relatively easy | High force | 1970 Zoltan U.S. Pat. No. |
| | an ink reservoir, | to fabricate single | required | 3,683,212 |
| | forcing ink from a | nozzles from glass | Inefficient | |
| | constricted nozzle. | tubing as | Difficult to | |
| | | macroscopic | integrate with VLSI | |
| | | structures | processes | |
| Coil/uncoil | A coiled actuator | Easy to fabricate | Difficult to | IJ17, IJ21, IJ34, |
| | uncoils or coils more | as a planar VLSI | fabricate for non- | IJ35 |
| | tightly. The motion of | process | planar devices | |
| | the free end of the | Small area | Poor out-of-plane | |
| | actuator ejects the ink. | required, therefore | stiffness | |
| | | low cost | | |
| Bow | The actuator bows (or | Can increase the | Maximum travel | IJ16, IJ18, IJ27 |
| | buckles) in the middle | speed of travel | is constrained | |
| | when energized. | Mechanically | High force | |
| | | rigid | required | |
| Push-Pull | Two actuators control | The structure is | Not readily | IJ18 |
| | a shutter. One actuator | pinned at both ends, | suitable for ink jets | |
| | pulls the shutter, and | so has a high out-of- | which directly push | |
| | the other pushes it. | plane rigidity | the ink | |
| Curl | A set of actuators curl | Good fluid flow | Design | IJ20, IJ42 |
| inwards | inwards to reduce the | to the region behind | complexity | |
| | volume of ink that | the actuator | | |
| | they enclose. | increases efficiency | | |
| Curl | A set of actuators curl | Relatively simple | Relatively large | IJ43 |
| outwards | outwards, pressurizing | construction | chip area | |
| | ink in a chamber | | | |
| | surrounding the | | | |
| | actuators, and | | | |
| | expelling ink from a | | | |
| | nozzle in the chamber. | | | |
| Iris | Multiple vanes enclose | High efficiency | High fabrication | IJ22 |
| | a volume of ink. These | Small chip area | complexity | |
| | simultaneously rotate, | | Not suitable for | |
| | reducing the volume | | pigmented inks | |
| | between the vanes. | | | |
| Acoustic | The actuator vibrates | The actuator can | Large area | 1993 Hadimioglu |
| vibration | at a high frequency. | be physically distant | required for | et al, EUP 550,192 |
| | | from the ink | efficient operation | 1993 Elrod et al, |
| | | | at useful frequencies | EUP 572,220 |
| | | | Acoustic | |
| | | | coupling and | |
| | | | crosstalk | |
| | | | Complex drive | |
| | | | circuitry | |
| | | | Poor control of | |
| | | | drop volume and | |
| | | | position | |
| None | In various ink jet | No moving parts | Various other | Silverbrook, EP |
| | designs the actuator | | tradeoffs are | 0771 658 A2 and |
| | does not move. | | required to | related patent |
| | | | eliminate moving | applications |
| | | | parts | Tone-jet |

NOZZLE REFILL METHOD

| | Description | Advantages | Disadvantages | Examples |
|---|---|---|---|---|
| Surface | This is the normal way | Fabrication | Low speed | Thermal ink jet |
| tension | that ink jets are | simplicity | Surface tension | Piezoelectric ink |
| | refilled. After the | Operational | force relatively | jet |
| | actuator is energized, | simplicity | small compared to | IJ01-IJ07, IJ10-IJ14, |
| | it typically returns | | actuator force | IJ16, IJ20, |
| | rapidly to its normal | | Long refill time | IJ22-IJ45 |
| | position. This rapid | | usually dominates | |
| | return sucks in air | | the total repetition | |
| | through the nozzle | | rate | |
| | opening. The ink | | | |
| | surface tension at the | | | |
| | nozzle then exerts a | | | |
| | small force restoring | | | |
| | the meniscus to a | | | |
| | minimum area. This | | | |
| | force refills the nozzle. | | | |
| Shuttered | Ink to the nozzle | High speed | Requires | IJ08, IJ13, IJ15, |
| oscillating | chamber is provided at | Low actuator | common ink | IJ17, IJ18, IJ19, |
| ink pressure | a pressure that | energy, as the | pressure oscillator | IJ21 |
| | oscillates at twice the | actuator need only | May not be | |
| | drop ejection | open or close the | suitable for | |
| | frequency. When a | shutter, instead of | pigmented inks | |
| | drop is to be ejected, | ejecting the ink drop | | |
| | the shutter is opened | | | |
| | for 3 half cycles: drop | | | |
| | ejection, actuator | | | |
| | return, and refill. The | | | |
| | shutter is then closed | | | |
| | to prevent the nozzle | | | |
| | chamber emptying | | | |
| | during the next | | | |
| | negative pressure | | | |
| | cycle. | | | |
| Refill | After the main | High speed, as | Requires two | IJ09 |
| actuator | actuator has ejected a | the nozzle is | independent | |
| | drop a second (refill) | actively refilled | actuators per nozzle | |
| | actuator is energized. | | | |
| | The refill actuator | | | |
| | pushes ink into the | | | |
| | nozzle chamber. The | | | |
| | refill actuator returns | | | |
| | slowly, to prevent its | | | |
| | return from emptying | | | |
| | the chamber again. | | | |
| Positive ink | The ink is held a slight | High refill rate, | Surface spill | Silverbrook, EP |
| pressure | positive pressure. | therefore a high | must be prevented | 0771 658 A2 and |
| | After the ink drop is | drop repetition rate | Highly | related patent |
| | ejected, the nozzle | is possible | hydrophobic print | applications |
| | chamber fills quickly | | head surfaces are | Alternative for:, |
| | as surface tension and | | required | IJ01-IJ07, IJ10-IJ14, |
| | ink pressure both | | | IJ16, IJ20, IJ22-IJ45 |
| | operate to refill the | | | |
| | nozzle. | | | |

METHOD OF RESTRICTING BACK-FLOW THROUGH INLET

| | Description | Advantages | Disadvantages | Examples |
|---|---|---|---|---|
| Long inlet | The ink inlet channel | Design simplicity | Restricts refill | Thermal ink jet |
| channel | to the nozzle chamber | Operational | rate | Piezoelectric ink |
| | is made long and | simplicity | May result in a | jet |
| | relatively narrow, | Reduces | relatively large chip | IJ42, IJ43 |
| | relying on viscous | crosstalk | area | |
| | drag to reduce inlet | | Only partially | |
| | back-flow. | | effective | |
| Positive ink | The ink is under a | Drop selection | Requires a | Silverbrook, EP |
| pressure | positive pressure, so | and separation | method (such as a | 0771 658 A2 and |
| | that in the quiescent | forces can be | nozzle rim or | related patent |
| | state some of the ink | reduced | effective | applications |
| | drop already protrudes | Fast refill time | hydrophobizing, or | Possible |
| | from the nozzle. | | both) to prevent | operation of the |
| | This reduces the | | flooding of the | following: IJ01-IJ07, |
| | pressure in the nozzle | | ejection surface of | IJ09-IJ12, |
| | chamber which is | | the print head. | IJ14, IJ16, IJ20, |
| | required to eject a | | | IJ22,, IJ23-IJ34, |
| | certain volume of ink. | | | IJ36-IJ41, IJ44 |
| | The reduction in | | | |
| | chamber pressure | | | |
| | results in a reduction | | | |
| | in ink pushed out | | | |
| | through the inlet. | | | |
| Baffle | One or more baffles | The refill rate is | Design | HP Thermal Ink |
| | are placed in the inlet | not as restricted as | complexity | Jet |
| | ink flow. When the | the long inlet | May increase | Tektronix |
| | actuator is energized, | method. | fabrication | piezoelectric ink jet |
| | the rapid ink | Reduces | complexity (e.g. | |
| | movement creates | crosstalk | Tektronix hot melt | |
| | eddies which restrict | | Piezoelectric print | |
| | the flow through the | | heads). | |
| | inlet. The slower refill | | | |
| | process is unrestricted, | | | |
| | and does not result in | | | |
| | eddies. | | | |
| Flexible flap | In this method recently | Significantly | Not applicable to | Canon |
| restricts | disclosed by Canon, | reduces back-flow | most ink jet | |
| inlet | the expanding actuator | for edge-shooter | configurations | |
| | (bubble) pushes on a | thermal ink jet | Increased | |
| | flexible flap that | devices | fabrication | |
| | restricts the inlet. | | complexity | |
| | | | Inelastic | |
| | | | deformation of | |
| | | | polymer flap results | |
| | | | in creep over | |
| | | | extended use | |
| Inlet filter | A filter is located | Additional | Restricts refill | IJ04, IJ12, IJ24, |
| | between the ink inlet | advantage of ink | rate | IJ27, IJ29, IJ30 |
| | and the nozzle | filtration | May result in | |
| | chamber. The filter | Ink filter may be | complex | |
| | has a multitude of | fabricated with no | construction | |
| | small holes or slots, | additional process | | |
| | restricting ink flow. | steps | | |
| | The filter also removes | | | |
| | particles which may | | | |
| | block the nozzle. | | | |
| Small inlet | The ink inlet channel | Design simplicity | Restricts refill | IJ02, IJ37, IJ44 |
| compared | to the nozzle chamber | | rate | |
| to nozzle | has a substantially | | May result in a | |
| | smaller cross section | | relatively large chip | |
| | than that of the nozzle, | | area | |
| | resulting in easier ink | | Only partially | |
| | egress out of the | | effective | |
| | nozzle than out of the | | | |
| | inlet. | | | |
| Inlet shutter | A secondary actuator | Increases speed | Requires separate | IJ09 |
| | controls the position of | of the ink-jet print | refill actuator and | |
| | a shutter, closing off | head operation | drive circuit | |
| | the ink inlet when the | | | |
| | main actuator is | | | |
| | energized. | | | |
| The inlet is | The method avoids the | Back-flow | Requires careful | IJ01, IJ03, 1J05, |
| located | problem of inlet back- | problem is | design to minimize | IJ06, IJ07, IJ10, |
| behind the | flow by arranging the | eliminated | the negative | IJ11, IJ14, IJ16, |
| ink-pushing | ink-pushing surface of | | pressure behind the | IJ22, IJ23, IJ25, |
| surface | the actuator between | | paddle | IJ28, IJ31, IJ32, |
| | the inlet and the | | | IJ33, IJ34, IJ35, |
| | nozzle. | | | IJ36, IJ39, IJ40, |
| | | | | IJ41 |
| Part of the | The actuator and a | Significant | Small increase in | IJ07, IJ20, IJ26, |
| actuator | wall of the ink | reductions in back- | fabrication | IJ38 |
| moves to | chamber are arranged | flow can be | complexity | |
| shut off the | so that the motion of | achieved | | |
| inlet | the actuator closes off | Compact designs | | |
| | the inlet. | possible | | |
| Nozzle | In some configurations | Ink back-flow | None related to | Silverbrook, EP |
| actuator | of ink jet, there is no | problem is | ink back-flow on | 0771 658 A2 and |
| does not | expansion or | eliminated | actuation | related patent |
| result in ink | movement of an | | | applications |
| back-flow | actuator which may | | | Valve-jet |
| | cause ink back-flow | | | Tone-jet |
| | through the inlet. | | | |

| | | | |
|---|---|---|---|
| Description | Advantages | Disadvantages | Examples |

NOZZLE CLEARING METHOD

| | | | | |
|---|---|---|---|---|
| Normal | All of the nozzles are | No added | May not be | Most ink jet |
| nozzle firing | fired periodically, | complexity on the | sufficient to | systems |
| | before the ink has a | print head | displace dried ink | IJ01, IJ02, IJ03, |
| | chance to dry. When | | | IJ04, IJ05, IJ06, |
| | not in use the nozzles | | | IJ07, IJ09, IJ10, |
| | are sealed (capped) | | | IJ11, IJ12, IJ14, |
| | against air. | | | IJ16, IJ20, IJ22, |
| | The nozzle firing is | | | IJ23, IJ24, IJ25, |
| | usually performed | | | IJ26, IJ27, IJ28, |
| | during a special | | | IJ29, IJ30, IJ31, |
| | clearing cycle, after | | | IJ32, IJ33, IJ34, |
| | first moving the print | | | IJ36, IJ37, IJ38, |
| | head to a cleaning | | | IJ39, IJ40,, IJ41, |
| | station. | | | IJ42, IJ43, IJ44,, |
| | | | | IJ45 |
| Extra | In systems which heat | Can be highly | Requires higher | Silverbrook, EP |
| power to | the ink, but do not boil | effective if the | drive voltage for | 0771 658 A2 and |
| ink heater | it under normal | heater is adjacent to | clearing | related patent |
| | situations, nozzle | the nozzle | May require | applications |
| | clearing can be | | larger drive | |
| | achieved by over- | | transistors | |
| | powering the heater | | | |
| | and boiling ink at the | | | |
| | nozzle. | | | |
| Rapid | The actuator is fired in | Does not require | Effectiveness | May be used |
| success-ion | rapid succession. In | extra drive circuits | depends | with: IJ01, IJ02, |
| of actuator | some configurations, | on the print head | substantially upon | IJ03, IJ04, IJ05, |
| pulses | this may cause heat | Can be readily | the configuration of | IJ06, IJ07, IJ09, |
| | build-up at the nozzle | controlled and | the ink jet nozzle | IJ10, IJ11, IJ14, |
| | which boils the ink, | initiated by digital | | IJ16, IJ20, IJ22, |
| | clearing the nozzle. In | logic | | IJ23, IJ24, IJ25, |
| | other situations, it may | | | IJ27, IJ28, IJ29, |
| | cause sufficient | | | IJ30, IJ31, IJ32, |
| | vibrations to dislodge | | | IJ33, IJ34, IJ36, |
| | clogged nozzles. | | | IJ37, IJ38, IJ39, |
| | | | | IJ40, IJ41, IJ42, |
| | | | | IJ43, IJ44, IJ45 |
| Extra | Where an actuator is | A simple | Not suitable | May be used |
| power to | not normally driven to | solution where | where there is a | with: IJ03, IJ09, |
| ink pushing | the limit of its motion, | applicable | hard limit to | IJ16, IJ20, IJ23, |
| actuator | nozzle clearing may be | | actuator movement | IJ24, IJ25, IJ27, |
| | assisted by providing | | | IJ29, IJ30, IJ31, |
| | an enhanced drive | | | IJ32, IJ39, IJ40, |
| | signal to the actuator. | | | IJ41, IJ42, IJ43, |
| | | | | IJ44, IJ45 |
| Acoustic | An ultrasonic wave is | A high nozzle | High | IJ08, IJ13, IJ15, |
| resonance | applied to the ink | clearing capability | implementation cost | IJ17, IJ18, IJ19, |
| | chamber. This wave is | can be achieved | if system does not | IJ21 |
| | of an appropriate | May be | already include an | |
| | amplitude and | implemented at very | acoustic actuator | |
| | frequency to cause | low cost in systems | | |
| | sufficient force at the | which already | | |
| | nozzle to clear | include acoustic | | |
| | blockages. This is | actuators | | |
| | easiest to achieve if | | | |
| | the ultrasonic wave is | | | |
| | at a resonant | | | |
| | frequency of the ink | | | |
| | cavity. | | | |
| Nozzle | A microfabricated | Can clear | Accurate | Silverbrook, EP |
| clearing | plate is pushed against | severely clogged | mechanical | 0771 658 A2 and |
| plate | the nozzles. The plate | nozzles | alignment is | related patent |
| | has a post for every | | required | applications |
| | nozzle. A post moves | | Moving parts are | |
| | through each nozzle, | | required | |
| | displacing dried ink. | | There is risk of | |
| | | | damage to the | |
| | | | nozzles | |
| | | | Accurate | |
| | | | fabrication is | |
| | | | required | |
| Ink | The pressure of the ink | May be effective | Requires | May be used |
| pressure | is temporarily | where other | pressure pump or | with all IJ series ink |
| pulse | increased so that ink | methods cannot be | other pressure | jets |
| | streams from all of the | used | actuator | |
| | nozzles. This may be | | Expensive | |
| | used in conjunction | | Wasteful of ink | |
| | with actuator | | | |
| | energizing. | | | |
| Print head | A flexible ‘blade’ is | Effective for | Difficult to use if | Many ink jet |
| wiper | wiped across the print | planar print head | print head surface is | systems |
| | head surface. The | surfaces | non-planar or very | |
| | blade is usually | Low cost | fragile | |
| | fabricated from a | | Requires | |
| | flexible polymer, e.g. | | mechanical parts | |
| | rubber or synthetic | | Blade can wear | |
| | elastomer. | | out in high volume | |
| | | | print systems | |
| Separate | A separate heater is | Can be effective | Fabrication | Can be used with |
| ink boiling | provided at the nozzle | where other nozzle | complexity | many IJ series ink |
| heater | although the normal | clearing methods | | jets |
| | drop e-ection | cannot be used | | |
| | mechanism does not | Can be | | |
| | require it. The heaters | implemented at no | | |
| | do not require | additional cost in | | |
| | individual drive | some ink jet | | |
| | circuits, as many | configurations | | |
| | nozzles can be cleared | | | |
| | simultaneously, and no | | | |
| | imaging is required. | | | |

NOZZLE PLATE CONSTRUCTION

| | | | | |
|---|---|---|---|---|
| Electroformed | A nozzle plate is | Fabrication | High | Hewlett Packard |
| nickel | separately fabricated | simplicity | temperatures and | Thermal Ink jet |
| | from electroformed | | pressures are | |
| | nickel, and bonded to | | required to bond | |
| | the print head chip. | | nozzle plate | |
| | | | Minimum | |
| | | | thickness constraints | |
| | | | Differential | |
| | | | thermal expansion | |
| Laser | Individual nozzle | No masks | Each hole must | Canon Bubblejet |
| ablated or | holes are ablated by an | required | be individually | 1988 Sercel et |
| drilled | intense UV laser in a | Can be quite fast | formed | al., SPIE, Vol. 998 |
| polymer | nozzle plate, which is | Some control | Special | Excimer Beam |
| | typically a polymer | over nozzle profile | equipment required | Applications, pp. |
| | such as polyimide or | is possible | Slow where there | 76-83 |
| | polysulphone | Equipment | are many thousands | 1993 Watanabe |
| | | required is relatively | of nozzles per print | et al., U.S. Pat. No. |
| | | low cost | head | 5,208,604 |
| | | | May produce thin | |
| | | | burrs at exit holes | |
| Silicon | A separate nozzle | High accuracy is | Two part | K. Bean, IEEE |
| micromachined | plate is | attainable | construction | Transactions on |
| | micromachined from | | High cost | Electron Devices, |
| | single crystal silicon, | | Requires | Vol. ED-25, No. 10, |
| | and bonded to the | | precision alignment | 1978, pp 1185-1195 |
| | print head wafer. | | Nozzles may be | Xerox 1990 |
| | | | clogged by adhesive | Hawkins et al., U.S. Pat. No. |
| | | | | 4,899,181 |
| Glass | Fine glass capillaries | No expensive | Very small | 1970 Zoltan U.S. Pat. No. |
| capillaries | are drawn from glass | equipment required | nozzle sizes are | 3,683,212 |
| | tubing. This method | Simple to make | difficult to form | |
| | has been used for | single nozzles | Not suited for | |
| | making individual | | mass production | |
| | nozzles, but is difficult | | | |
| | to use for bulk | | | |
| | manufacturing of print | | | |
| | heads with thousands | | | |
| | of nozzles. | | | |
| Monolithic, | The nozzle plate is | High accuracy | Requires | Silverbrook, EP |
| surface | deposited as a layer | (<1 μm) | sacrificial layer | 0771 658 A2 and |
| micromachined | using standard VLSI | Monolithic | under the nozzle | related patent |
| using VLSI | deposition techniques. | Low cost | plate to form the | applications |
| lithographic | Nozzles are etched in | Existing | nozzle chamber | IJ01, IJ02, IJ04, |
| processes | the nozzle plate using | processes can be | Surface may be | IJ11, IJ12, IJ17, |
| | VLSI lithography and | used | fragile to the touch | IJ18, IJ20, IJ22, |
| | etching. | | | IJ24, IJ27, IJ28, |
| | | | | IJ29, IJ30, IJ31, |
| | | | | IJ32, IJ33, IJ34, |
| | | | | IJ36, IJ37, IJ38, |
| | | | | IJ39, IJ40, IJ41, |
| | | | | IJ42, IJ43, IJ44 |
| Monolithic, | The nozzle plate is a | High accuracy | Requires long | IJ03, IJ05, IJ06, |
| etched | buried etch stop in the | (<1 μm) | etch times | IJ07, IJ08, IJ09, |
| through | wafer. Nozzle | Monolithic | Requires a | IJ10, IJ13, IJ14, |
| substrate | chambers are etched in | Low cost | support wafer | IJ15, IJ16, IJ19, |
| | the front of the wafer, | No differential | | IJ21, IJ23, IJ25, |
| | and the wafer is | expansion | | IJ26 |
| | thinned from the back | | | |
| | side. Nozzles are then | | | |
| | etched in the etch stop | | | |
| | layer. | | | |
| No nozzle | Various methods have | No nozzles to | Difficult to | Ricoh 1995 |
| plate | been tried to eliminate | become clogged | control drop | Sekiya et al U.S. Pat. No. |
| | the nozzles entirely, to | | position accurately | 5,412,413 |
| | prevent nozzle | | Crosstalk | 1993 Hadimioglu |
| | clogging. These | | problems | et al EUP 550,192 |
| | include thermal bubble | | | 1993 Elrod et al |
| | mechanisms and | | | EUP 572,220 |
| | acoustic lens | | | |
| | mechanisms | | | |
| Trough | Each drop ejector has | Reduced | Drop firing | IJ35 |
| | a trough through | manufacturing | direction is sensitive | |
| | which a paddle moves. | complexity | to wicking. | |
| | There is no nozzle | Monolithic | | |
| | plate. | | | |
| Nozzle slit | The elimination of | No nozzles to | Difficult to | 1989 Saito et al |
| instead of | nozzle holes and | become clogged | control drop | U.S. Pat. No. 4,799,068 |
| individual | replacement by a slit | | position accurately | |
| nozzles | encompassing many | | Crosstalk | |
| | actuator positions | | problems | |
| | reduces nozzle | | | |
| | clogging, but increases | | | |
| | crosstalk due to ink | | | |
| | surface waves | | | |

DROP EJECTION DIRECTION

| | Description | Advantages | Disadvantages | Examples |
|---|---|---|---|---|
| Edge | Ink flow is along the | Simple | Nozzles limited | Canon Bubblejet |
| (‘edge | surface of the chip, | construction | to edge | 1979 Endo et al GB |
| shooter’) | and ink drops are | No silicon | High resolution | patent 2,007,162 |
| | ejected from the chip | etching required | is difficult | Xerox heater-in- |
| | edge. | Good heat | Fast color | pit 1990 Hawkins et |
| | | sinking via substrate | printing requires | al U.S. Pat. No. 4,899,181 |
| | | Mechanically | one print head per | Tone-jet |
| | | strong | color | |
| | | Ease of chip | | |
| | | handing | | |
| Surface | Ink flow is along the | No bulk silicon | Maximum ink | Hewlett-Packard |
| (‘roof | surface of the chip, | etching required | flow is severely | TIJ 1982 Vaught et |
| shooter’) | and ink drops are | Silicon can make | restricted | al U.S. Pat. No. 4,490,728 |
| | ejected from the chip | an effective heat | | IJ02, IJ11, IJ12, |
| | surface, normal to the | sink | | IJ20, IJ22 |
| | plane of the chip. | Mechanical | | |
| | | strength | | |
| Through | Ink flow is through the | High ink flow | Requires bulk | Silverbrook, EP |
| chip, | chip, and ink drops are | Suitable for | silicon etching | 0771 658 A2 and |
| forward | ejected from the front | pagewidth print | | related patent |
| (‘up | surface of the chip. | heads | | applications |
| shooter’) | | High nozzle | | IJ04, IJ17, IJ18, |
| | | packing density | | IJ24, IJ27-IJ45 |
| | | therefore low | | |
| | | manufacturing cost | | |
| Through | Ink flow is through the | High ink flow | Requires wafer | IJ01, IJ03, IJ05, |
| chip, | chip, and ink drops are | Suitable for | thinning | IJ06, IJ07, IJ08, |
| reverse | ejected from the rear | pagewidth print | Requires special | IJ09, IJ10, IJ13, |
| (‘down | surface of the chip. | heads | handling during | IJ14, IJ15, IJ16, |
| shooter’) | | High nozzle | manufacture | IJ19, IJ21, IJ23, |
| | | packing density | | IJ25, IJ26 |
| | | therefore low | | |
| | | manufacturing cost | | |
| Through | Ink flow is through the | Suitable for | Pagewidth print | Epson Stylus |
| actuator | actuator, which is not | piezoelectric print | heads require | Tektronix hot |
| | fabricated as part of | heads | several thousand | melt piezoelectric |
| | the same substrate as | | connections to drive | ink jets |
| | the drive transistors. | | circuits | |
| | | | Cannot be | |
| | | | manufactured in | |
| | | | standard CMOS | |
| | | | fabs | |
| | | | Complex | |
| | | | assembly required | |

INK TYPE

| | Description | Advantages | Disadvantages | Examples |
|---|---|---|---|---|
| Aqueous, | Water based ink which | Environmentally | Slow drying | Most existing ink |
| dye | typically contains: | friendly | Corrosive | jets |
| | water, dye, surfactant, | No odor | Bleeds on paper | All IJ series ink |
| | humectant, and | | May | jets |
| | biocide. | | strikethrough | Silverbrook, EP |
| | Modern ink dyes have | | Cockles paper | 0771 658 A2 and |
| | high water-fastness, | | | related patent |
| | light fastness | | | applications |
| Aqueous, | Water based ink which | Environmentally | Slow drying | IJ02, IJ04, IJ21, |
| pigment | typically contains: | friendly | Corrosive | IJ26, IJ27, IJ30 |
| | water, pigment, | No odor | Pigment may | Silverbrook, EP |
| | surfactant, humectant, | Reduced bleed | clog nozzles | 0771 658 A2 and |
| | and biocide. | Reduced wicking | Pigment may | related patent |
| | Pigments have an | Reduced | clog actuator | applications |
| | advantage in reduced | strikethrough | mechanisms | Piezoelectric ink- |
| | bleed, wicking and | | Cockles paper | jets |
| | strikethrough. | | | Thermal ink jets |
| | | | | (with significant |
| | | | | restrictions) |
| Methyl | MEK is a highly | Very fast drying | Odorous | All IJ series ink |
| Ethyl | volatile solvent used | Prints on various | Flammable | jets |
| Ketone | for industrial printing | substrates such as | | |
| (MEK) | on difficult surfaces | metals and plastics | | |
| | such as aluminum | | | |
| | cans. | | | |
| Alcohol | Alcohol based inks | Fast drying | Slight odor | All IJ series ink |
| (ethanol, 2- | can be used where the | Operates at sub- | Flammable | jets |
| butanol, | printer must operate at | freezing | | |
| and others) | temperatures below | temperatures | | |
| | the freezing point of | Reduced paper | | |
| | water. An example of | cockle | | |
| | this is in-camera | Low cost | | |
| | consumer | | | |
| | photographic printing. | | | |
| Phase | The ink is solid at | No drying time- | High viscosity | Tektronix hot |
| change | room temperature, and | ink instantly freezes | Printed ink | melt piezoelectric |
| (hot melt) | is melted in the print | on the print medium | typically has a | ink jets |
| | head before jetting. | Almost any print | ‘waxy’ feel | 1989 Nowak |
| | Hot melt inks are | medium can be used | Printed pages | U.S. Pat. No. 4,820,346 |
| | usually wax based, | No paper cockle | may ‘block’ | All IJ series ink |
| | with a melting point | occurs | Ink temperature | jets |
| | around 80° C. After | No wicking | may be above the | |
| | jetting the ink freezes | occurs | curie point of | |
| | almost instantly upon | No bleed occurs | permanent magnets | |
| | contacting the print | No strikethrough | Ink heaters | |
| | medium or a transfer | occurs | consume power | |
| | roller. | | Long warm-up | |
| | | | time | |
| Oil | Oil based inks are | High solubility | High viscosity: | All IJ series ink |
| | extensively used in | medium for some | this is a significant | jets |
| | offset printing. They | dyes | limitation for use in | |
| | have advantages in | Does not cockle | ink jets, which | |
| | improved | paper | usually require a | |
| | characteristics on | Does not wick | low viscosity. Some | |
| | paper (especially no | through paper | short chain and | |
| | wicking or cockle). | | multi-branched oils | |
| | Oil soluble dies and | | have a sufficiently | |
| | pigments are required. | | low viscosity. | |
| | | | Slow drying | |
| Microemulsion | A microemulsion is a | Stops ink bleed | Viscosity higher | All IJ series ink |
| | stable, self forming | High dye | than water | jets |
| | emulsion of oil, water, | solubility | Cost is slightly | |
| | and surfactant. The | Water, oil, and | higher than water | |
| | characteristic drop size | amphiphilic soluble | based ink | |
| | is less than 100 nm, | dies can be used | High surfactant | |
| | and is determined by | Can stabilize | concentration | |
| | the preferred curvature | pigment | required (around | |
| | of the surfactant. | suspensions | 5%) | |

1. A printhead comprising:
a substrate including a plurality of nozzles for ejecting ink droplets onto a print medium, each nozzle having a nozzle aperture defined in an ink ejection surface of the substrate; and
a plurality of formations on the ink ejection surface, the surface formations being configured to isolate each nozzle from at least one adjacent nozzle.

2. The printhead of claim 1, wherein the surface formations each have a hydrophobic surface.

3. The printhead of claim 1, wherein the surface formations are configured in a plurality of nozzle enclosures, each nozzle enclosure comprising sidewalls surrounding a respective nozzle, the sidewalls forming a seal with the ink ejection surface, thereby isolating each nozzle from at least one adjacent nozzle.

4. The printhead of claim 3, wherein each nozzle enclosure further comprises a roof spaced apart from the respective nozzle aperture, the roof having a roof opening aligned with its respective nozzle aperture, thereby allowing ejected ink droplets to pass therethrough onto the print medium.

5. The printhead of claim 4, wherein the sidewalls extend from each roof to the ink ejection surface.

6. The printhead of claim 5, wherein the sidewalls extend from a perimeter region of each roof.

7. The printhead of claim 1, which is a pagewidth inkjet printhead.

8. The printhead of claim 1, wherein the printhead has a nozzle density sufficient to print at up to 1600 dpi.

9. A printer comprising the printhead according to claim 1.

10. A method of printing from the printhead of claim 1, whilst minimizing cross-contamination of ink between adjacent nozzles, the method comprising the steps of:
(a) providing a printhead comprising:
a substrate including a plurality of nozzles for ejecting ink droplets onto a print medium, each nozzle having a nozzle aperture defined in an ink ejection surface of the substrate; and
a plurality of formations on the ink ejection surface, the surface formations being configured to isolate each nozzle from at least one adjacent nozzle; and
(b) printing onto a print medium using said printhead.

11. A method of fabricating the printhead of claim 1 having isolated nozzles, the method comprising the steps of:
(a) providing a substrate, the substrate including a plurality of nozzles for ejecting ink droplets onto a print medium, each nozzle having a nozzle aperture defined in an ink ejection surface of the substrate;
(b) depositing a layer of photoresist over the ink ejection surface;
(c) defining recesses in the photoresist, each recess revealing a portion of the ink ejection surface surrounding a respective nozzle aperture;
(d) depositing a roof material over the photoresist and into the recesses;
(e) etching the roof material to define a nozzle enclosure around each nozzle aperture, each nozzle enclosure having an opening defined in a roof and sidewalls extending from the roof to the ink ejection surface; and
(f) removing the photoresist.
